(19) United States
(12) Patent Application Publication
(10) Pub. No.: US 2026/0034818 A1
(43) Pub. Date: Feb. 5, 2026

(54) RIBBON CARTRIDGE AUTOMATIC CENTERING SYSTEM AND METHOD

(71) Applicant: Brady Worldwide, Inc., Milwaukee, WI (US)

(72) Inventors: Don Rodriguez David, Singapore (SG); Aaron P. Ordoña, Singapore (SG); Mui Heng Too, Singapore (SG)

(21) Appl. No.: 18/790,106

(22) Filed: Jul. 31, 2024

(51) Int. Cl. B41J 33/00; B41J 2/325; B41J 32/00

(52) U.S. Cl. CPC B41J 33/006; B41J 2/325; B41J 32/00

(57) ABSTRACT

The present disclosure is directed to a system for installing ribbon material in a printer. The system includes a spindle provided in the form of a spindle arm and a key associated with the spindle arm. The system also includes a ribbon cartridge having a keyway arranged to align with the key of the spindle arm and a ribbon roll including a supply of ribbon material. Engagement between the key and the keyway positions the ribbon cartridge on the spindle arm in a correct orientation.

### CROSS REFERENCE TO RELATED APPLICATIONS

None.

### BACKGROUND

Thermal transfer printers employ a digital printing method that uses a ribbon and a printhead to selectively transfer ink onto a substrate (e.g., paper or another form of printable media). This method is known in the art to produce high-quality, high-resolution, durable prints. For example, thermal transfer printers are commonly used to print labels (e.g., barcodes) that will be used for long-term applications or that will be exposed to harsh conditions such as heat, ultraviolet light, moisture, and chemicals. Thermal transfer printers are also capable of handling high-volume print jobs in an efficient and cost-effective manner. For these and other reasons, thermal transfer printers are commonplace in a variety of industries including retail, healthcare, manufacturing, and others.

However, thermal transfer printers present certain challenges, particularly with respect to the ribbon material that must be installed before the printer can function. The ribbon material is generally provided in the form of a thin film coated on one side with ink (e.g., wax, resin, or a wax-resin compound) that is melted via the application of heat from a printhead and transferred onto a printable media to produce the desired print. The ribbon material is wound around a core to form a roll which is installed on a ribbon supply spindle before the printer can be used.

One common challenge with thermal transfer printers is the difficulty of correctly installing ribbon rolls of different widths. For example, many thermal printers require a ribbon roll to be installed centrally on a spindle for the printer to function properly. Thus, when installing ribbon rolls of different sizes, users may be required to estimate the correct position of the roll along the spindle—an inherently subjective method prone to error. Some thermal transfer printers have been designed with mechanisms to help users correctly install ribbon rolls of different sizes. For example, some printers use markings or guides on the spindle to help the user more accurately approximate the desired (e.g., central) position. However, these methods are still vulnerable to user error and may fail to prevent incorrect installation, resulting in potential damage to the printhead or other components of the printer, missing prints, and/or poor print image quality in some cases.

Additionally, the ribbon roll must also be oriented correctly when installed on the spindle for the printer to function properly. When a user installs a ribbon roll in the incorrect orientation, the ink-coated side of the ribbon will not face the printable media, thereby causing blank printouts. Operating a printer with the ribbon roll installed in the incorrect orientation may lead to further issues including wasted ribbon material, breaks or tears in the ribbon material, potential damage to the printhead, jams due to wrinkled or bunched ribbon material, and/or other undesirable outcomes. Some devices utilize sensors mounted along the ribbon path to detect whether the ribbon roll is oriented correctly. However, these sensors increase the cost of both producing and purchasing the device and introduce unnecessary potential points of failure. Other devices utilize mechanical cover plates that aim to intuitively guide users to accurately install the ribbon roll; however, these devices do not eliminate the possibility that a roll could be installed incorrectly and cause significant damage to the printer.

In light of the above problems and in order to reduce or eliminate the risk of undesirable outcomes (e.g., potential damage to the printhead or printer, poor print image quality, etc.) associated with incorrect installation of the ribbon roll, there exists a need for a thermal transfer printer that ensures ribbon rolls of different sizes are installed in the proper position (e.g., centrally) and orientation with respect to the spindle.

### SUMMARY

The present systems and methods disclosed herein overcome many of the shortcomings and limitations of the prior art devices discussed above.

In one aspect, a system for installing ribbon material in a printer is disclosed. The system includes a spindle provided in the form of a spindle arm and a key associated with the spindle arm. The system also includes a ribbon cartridge having a keyway arranged to align with the key of the spindle arm and a ribbon roll including a supply of ribbon material. Engagement between the key and the keyway positions the ribbon cartridge on the spindle arm in a correct orientation.

In another aspect, a ribbon cartridge for installation on a spindle of a printer is disclosed. The ribbon cartridge includes a supply of ribbon material, and a ribbon holder for holding the supply of ribbon material. The ribbon holder includes a support member having a flange, a first opening extending through the flange, and a first fail-safe member disposed about the first opening. The ribbon holder also includes an end cap releasably couplable to the support member, the end cap including a second opening extending therethrough and a second fail-safe member disposed about the second opening. Then the first fail-safe member and the second fail-safe member are configured to engage at least a portion of the spindle when the ribbon cartridge is being installed in an incorrect orientation. Engagement between the spindle and one or both of the first fail-safe member and the second fail-safe member inhibits movement of the ribbon cartridge along the spindle.

In a further aspect, a method of installing a ribbon cartridge on a spindle of a printer is disclosed. The method includes the step of providing a ribbon cartridge. The ribbon cartridge includes a support element positioned at a first end of the ribbon cartridge. The support element includes a first opening and a keyway having an end wall. The ribbon cartridge also includes an end cap having a second opening that is positioned at a second end of the ribbon cartridge opposing the first end. The method also includes the steps of aligning the ribbon cartridge with the spindle such that the first end of the ribbon cartridge is positioned adjacent to the spindle and mounting the ribbon cartridge onto the spindle such that the spindle extends through the first opening before extending through the second opening. The method further includes the step of moving the ribbon cartridge along the spindle until the end wall of the keyway is engaged by a key positioned on the spindle.

### BRIEF DESCRIPTION OF THE DRAWINGS

FIG. 1 illustrates a front, top, and left side isometric view of an exemplary printer;

FIG. 2 illustrates a front, top, and right side isometric view of the printer of FIG. 1 in an open configuration;

FIG. 3A illustrates a schematic view of several components of the printer of FIG. 1 in a first, correct orientation;

FIG. 3B illustrates a schematic view of several components of the printer of FIG. 1 in a second, incorrect orientation;

FIG. 4 illustrates a left side elevational view of a first exemplary ribbon cartridge and a spindle for use with the printer of FIGS. 1-3B constructed according to the teachings of the present disclosure;

FIG. 5 illustrates a left side elevational view of a second exemplary ribbon cartridge for use with the printer of FIGS. 1-3B constructed according to the teachings of the present disclosure and the spindle of FIG. 4;

FIG. 6 illustrates a front, top, and left side isometric view of the spindle of FIG. 4;

FIG. 7 illustrates a front, top, and left side isometric view of a shaft of the spindle of FIG. 4;

FIG. 8 illustrates a front, top, and left side isometric view of a hub of the spindle of FIG. 4;

FIG. 9 illustrates a front, top, and left side isometric view of a first portion of the hub of FIG. 8;

FIG. 10 illustrates a bottom isometric view of the first portion of the hub of FIG. 8 with a sensor element disposed therein;

FIG. 11 illustrates a top isometric view of the sensor element of FIG. 10;

FIG. 12 illustrates a front, bottom, and left side isometric view of a second portion of the hub of FIG. 8 with two leaf springs disposed therein;

FIG. 13 illustrates a top isometric view of a leaf spring of FIG. 12;

FIG. 14 illustrates a front elevational view of the hub of FIG. 8;

FIG. 15 illustrates a left side elevational view of the spindle of FIG. 4;

FIG. 16 illustrates a front, top, and left side isometric view of the first exemplary ribbon cartridge of FIG. 4;

FIG. 17 illustrates a front and left side isometric view of a ribbon roll of the first exemplary ribbon cartridge of FIG. 4;

FIG. 18 illustrates a front, top, and left side isometric view of a ribbon holder of the first exemplary ribbon cartridge of FIG. 4;

FIG. 19 illustrates a rear, top, and left side isometric view of a support member of the ribbon holder of FIG. 18;

FIG. 20 illustrates a bottom plan view of the support member of FIG. 19;

FIG. 21 illustrates a left side elevational, cross-sectional view of the support member of FIG. 19 taken along the line 21-21 of FIG. 20;

FIG. 22 illustrates a rear elevational view of the support member of FIG. 19;

FIG. 23 illustrates a front and right side isometric view of an end cap of the ribbon holder of FIG. 18;

FIG. 24 illustrates a front elevational view of the end cap of FIG. 23;

FIG. 25 illustrates a front and top isometric view of the first exemplary ribbon cartridge of FIG. 4;

FIG. 26 illustrates a front, top, and left side isometric view of the second exemplary ribbon cartridge of FIG. 5;

FIG. 27 illustrates a front and left side isometric view of a ribbon roll of the second exemplary ribbon cartridge of FIG. 5;

FIG. 28 illustrates a front, top, and left side isometric view of a ribbon holder of the second exemplary ribbon cartridge of FIG. 5;

FIG. 29 illustrates a rear elevational view of a support member of the ribbon holder of FIG. 28;

FIG. 30 illustrates a top plan view of the support member of FIG. 29;

FIG. 31 illustrates a left side elevational, cross-sectional view of the support member of FIG. 29 taken along the line 31-31 of FIG. 30;

FIG. 32 illustrates a front elevational view of an end cap of the ribbon holder of FIG. 28;

FIG. 33 illustrates a front and top isometric view of the second exemplary ribbon cartridge of FIG. 5;

FIG. 34 illustrates a schematic view of a process for installing the second exemplary ribbon cartridge of FIG. 5 on the spindle of FIG. 4;

FIG. 35 illustrates a front, top, and left side isometric view of the second exemplary ribbon cartridge of FIG. 5 installed on the spindle of FIG. 4;

FIG. 36 illustrates a left side elevational, cross-sectional view of the second exemplary ribbon cartridge of FIG. 5 installed on the spindle of FIG. 4 taken along the line 36-36 of FIG. 35;

FIG. 37 illustrates a front elevational view of the support member of FIG. 29 installed on the spindle of FIG. 4;

FIG. 38 illustrates a front elevational view of the spindle of FIG. 4 showing the end cap of FIG. 32 installed on the spindle in a first, correct orientation;

FIG. 39 illustrates a rear elevational view of the spindle of FIG. 4 showing the end cap of FIG. 32 installed on the spindle in a second, incorrect orientation;

FIG. 40 illustrates a schematic view of a process for installing the first exemplary ribbon cartridge of FIG. 4 on the spindle of FIG. 4;

FIG. 41 illustrates a front, top, and left side isometric view of the first exemplary ribbon cartridge of FIG. 4 installed on the spindle of FIG. 4;

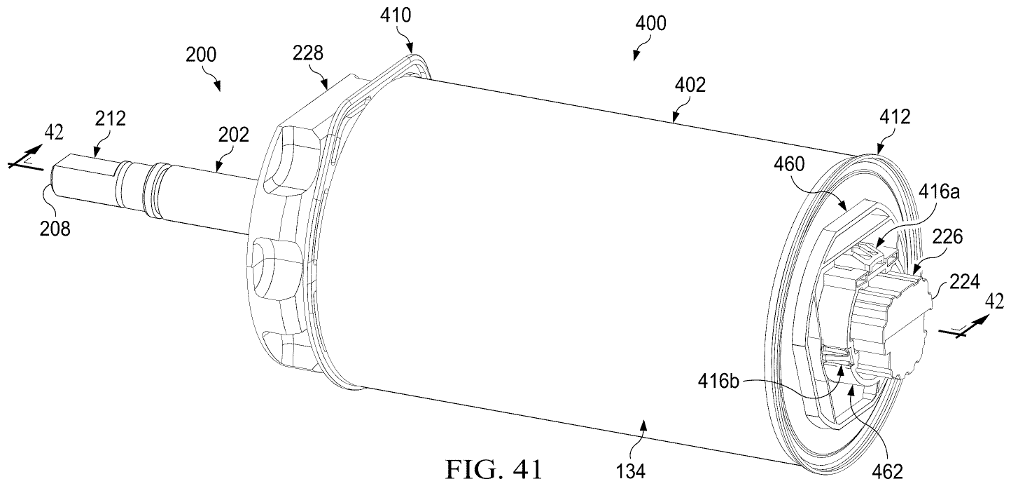

FIG. 42 illustrates a left side elevational, cross-sectional view of the ribbon cartridge of FIG. 4 installed on the spindle of FIG. 4 taken along the line 42-42 of FIG. 41; and

FIG. 43 is a flowchart illustrating a method of installing a ribbon cartridge on a spindle.

### DETAILED DESCRIPTION

Before any embodiments are described in detail, it is to be understood that the disclosure is not limited in its application to the details of construction and the arrangement of components set forth in the following description or illustrated in the following drawings, which is limited only by the claims that follow the present disclosure. The disclosure is capable of other embodiments, and of being practiced, or of being carried out, in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following description is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown but are to be accorded the widest scope consistent with the principles and features disclosed herein. The following detailed description is to be read with reference to the figures, in which like elements in different figures have like reference numerals. Skilled artisans will recognize the examples provided herein have many useful alternatives and fall within the scope of embodiments of the disclosure.

Additionally, while the following discussion may describe features associated with specific devices or embodiments, it is understood that additional devices and/or features can be used with the described systems and methods, and that the discussed devices and features are used to provide examples of possible embodiments, without being limited.

The present disclosure is directed to a ribbon cartridge and spindle designed to be used together. The spindle may be configured to quickly position ribbon rolls of different widths in a standardized location within a printing device (e.g., a thermal transfer printer). Additionally, the ribbon cartridge and spindle may be constructed to ensure that the ribbon cartridge is installed with the correct orientation, thereby ensuring an accurate ink face orientation of the ribbon roll, enabling the printing device to function properly, and avoiding poor print image quality and potential damage to internal components of the printing device.

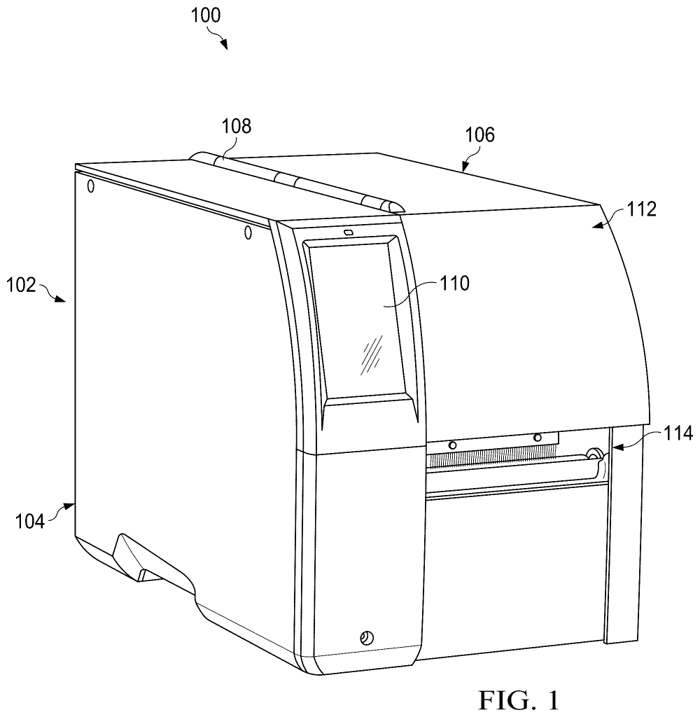

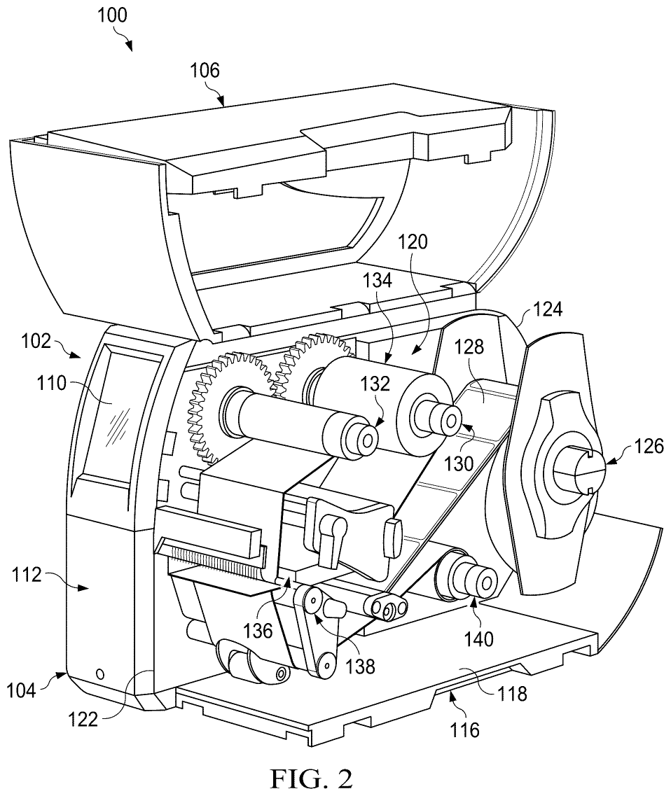

Referring first to FIGS. 1 and 2, an exemplary thermal transfer printer 100 is provided in the form of a housing 102 defining a base portion 104 and an enclosure cover 106. The base portion 104 and the enclosure cover 106 may be hingedly attached or otherwise coupled to one another such that the enclosure cover 106 may be removably opened and/or attached to allow access to the internal components of the printer 100 and to allow for installation or maintenance of the internal parts. For example, the enclosure cover 106 may be coupled to the base portion 104 via a hinge 108.

A user interface 110 may be located on a front face 112 of the printer 100. The user interface 110 may allow users to operate, service, or otherwise interface with the printer 100. For example, the user interface 110 may enable users to alter certain settings or preferences with respect to one or more print jobs. Additionally, the printer 100 may include an exit slot 114 provided in the form of a rectilinear opening between the base portion 104 and the enclosure cover 106 disposed on the front face 112. The exit slot 114 may provide an aperture through which printed media produced by the printer 100 may exit the printer 100, e.g., to be retrieved by a user.

As shown in FIG. 2, the enclosure cover 106 of the printer 100 is designed to move into an open configuration. In some instances, the enclosure cover 106 may be rotatable about an axis of connection with the base portion 104 formed by the hinge 108. Thus, a user may place the printer 100 in the open configuration by lifting the enclosure cover 106 away from the base portion 104 and causing it to rotate about the hinge, thereby exposing one or more internal components of the printer 100.

The base portion 104 may include a chassis 116 configured to support one or more internal components of the printer 100. The chassis 116 may be provided in the form of a floor 118 and a mounting wall 120 oriented in a plane that is substantially perpendicular to the floor 118. The mounting wall 120 may be formed integrally with or coupled to the floor 118 and extend upwardly therefrom. The mounting wall 120 may be defined by a front end 122 (the front end 122 corresponding to the front face 112 of the printer 100) and a rear end 124 opposing the front end 122. In some instances, the chassis 116 may be formed from cast aluminum. In other instances, the chassis 116 may be formed from any other suitable material.

Internal components of the printer 100 may be connected to the mounting wall 120 of the chassis 116. For example, a media holder 126 may be connected to the mounting wall 120 and may be positioned adjacent to the rear end 124 of the chassis 116. The media holder 126 is designed to retain and dispense a printable media 128 (e.g., adhesive labels or any other suitable media) from a roll as the printer 100 operates. The media holder 126 may be configured to support printable media 128 of different sizes (e.g., labels having different widths).

The chassis 116 may also support a ribbon supply spindle 130 and a waste ribbon spindle 132 connected to the mounting wall 120. The ribbon supply spindle 130 may be positioned on the mounting wall 120 proximate to the media holder 126, and the waste ribbon spindle 132 may be positioned between the ribbon supply spindle 130 and the front end 122 of the mounting wall 120. The ribbon supply spindle 130 is designed to retain and dispense ribbon material 134 from a roll in a similar manner to the media holder 126 as the printer 100 operates. During the printing process, printable media 128 from the media holder 126 and ribbon material 134 from the ribbon supply spindle 130 may each be directed toward the front end 122 of the mounting wall 120.

The printable media 128 and the ribbon material 134 may converge proximate to a printhead 136 and a platen roller 138. The printhead 136 and platen roller 138 may each be connected to the chassis 116 and positioned proximate to the front end 122 of the mounting wall 120. For example, the printhead 136 and platen roller 138 may be positioned on the mounting wall 120 so that the printhead 136 and platen roller 138 are positioned adjacent to the exit slot 114 when the enclosure cover 106 is placed in a closed configuration.

During printing, the printable media 128 and ribbon material 134 may pass between the printhead 136 and the platen roller 138. The printhead 136 may be configured to apply heat to the ribbon material 134 passing beneath it, thereby causing ink from the ribbon material to melt and adhere to an adjacent portion of the printable media 128. At the same time, the platen roller 138 may be configured to provide a smooth support surface to the printable media 128 and ribbon material 134 as they pass beneath the printhead 136 and come into contact with one another. For example, the platen roller 138 may apply a pressure against the printable media 128 and the ribbon material 134, thereby ensuring that each engages firmly with the printhead 136 such that ink from the ribbon material 134 is effectively transferred to the printable media 128.

Once the ink from the ribbon material 134 has been applied to the printable media 128 by the printhead 136, the printable media 128 may exit the printer 100 via the exit slot 114 and the ribbon material 134 may be directed to and collected on the waste ribbon spindle 132. In some instances, rather than exiting the printer 100 via the exit slot 114, the printable media 128 may be directed back toward the rear end 124 of the mounting wall 120 where it may be collected by a rewinder 140. In this way, the printer 100 may generate as an end product a roll of printed media (e.g., a roll of printed labels) to be later retrieved by a user, rather than supplying the finished product directly to a user via the exit slot 114.

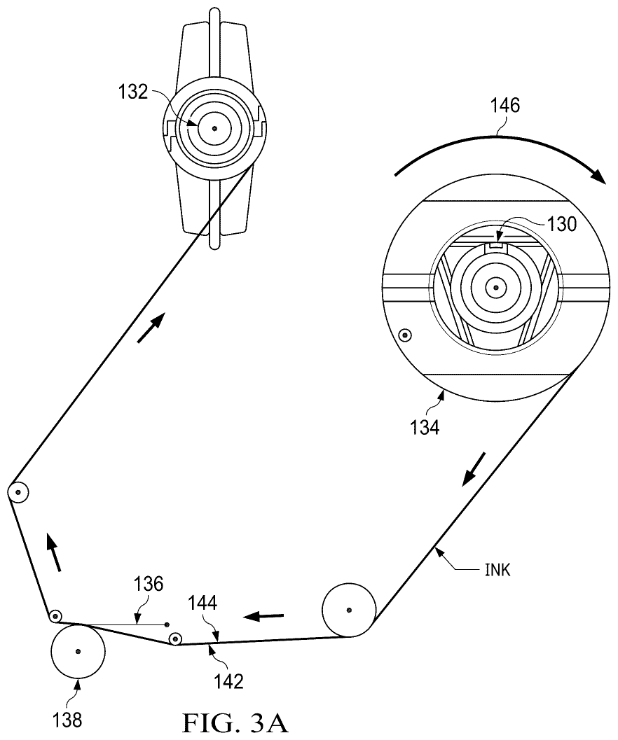

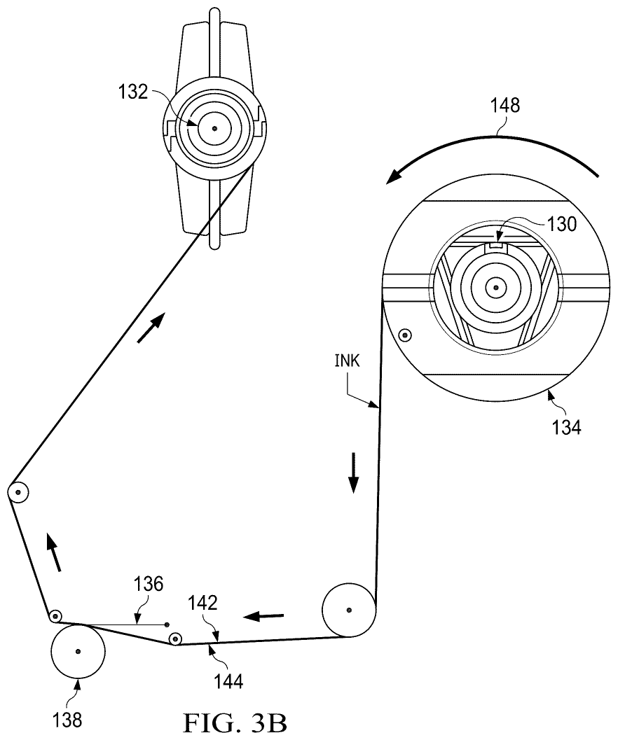

Turning to FIGS. 3A and 3B, the ribbon material 134 may include an active side 142 coated with ink and a blank side 144 that is bare (e.g., free from ink). Prior to use of the printer 100, the ribbon material 134 is installed on the ribbon supply spindle 130 such that the active side 142 is face down (e.g., adjacent to the platen roller 138) when the ribbon material 134 is fed between the printhead 136 and the platen roller 138. As printing operations are performed, used ribbon material 134 is collected (e.g., wound around) the waste ribbon spindle 132.

In a first, correct orientation as shown in FIG. 3A, the active side 142 is positioned on the side of the ribbon material 134 that faces the platen roller 138. Thus, the printhead 136 applies heat to the blank side 144 such that ink from the active side 142 melts and is transferred to the printable media 128 (not shown) positioned between the ribbon material 134 and the platen roller 138. In some instances, the ribbon supply spindle 130 may rotate in a clockwise direction 146 when the ribbon material 134 is installed in the first orientation.

In a second, incorrect orientation as shown in FIG. 3B, the blank side 144 is positioned on the side of the ribbon material 134 that faces the platen roller 138. Thus, the printhead 136 applies heat directly to the active side 142 such that ink is not transferred to the printable media 128 (see FIG. 2), resulting in blank printouts, wasted ribbon material, and/or other undesirable outcomes. In addition, applying heat directly to the active side 142 may transfer ink to the printhead 136 in some instances and cause damage thereto. In some instances, the ribbon supply spindle 130 may rotate in a counterclockwise direction 148 when the ribbon material 134 is installed in the second orientation, which may also cause damage to the spindle.

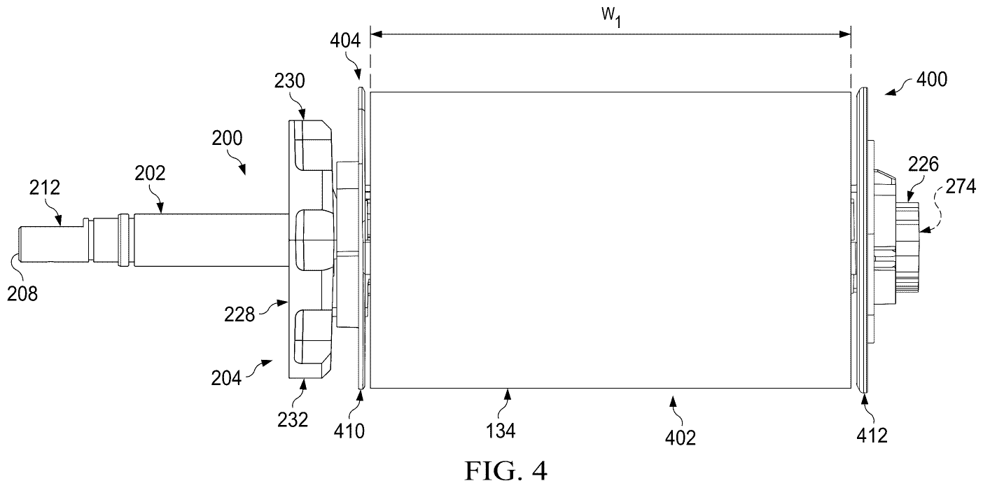

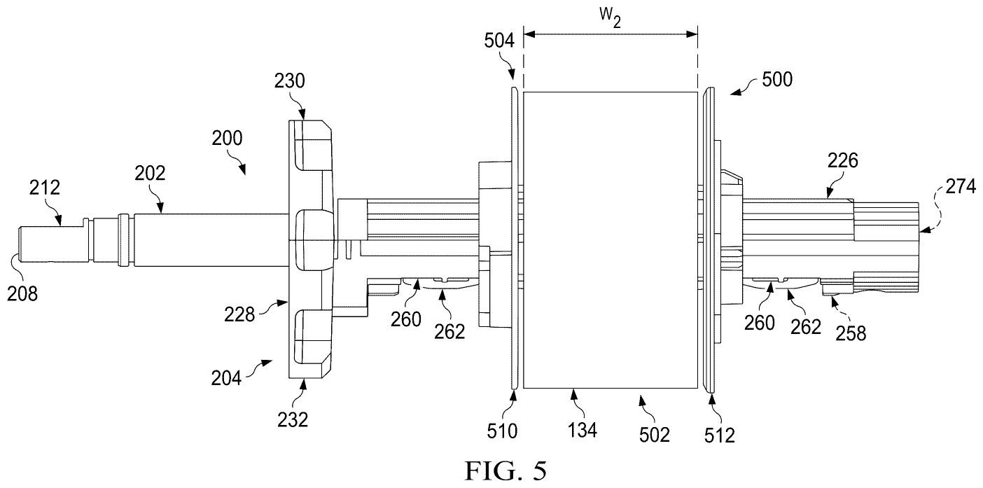

Now turning to FIGS. 4 and 5, a spindle 200 may provide ease and convenience to users by facilitating installation of ribbon cartridges having different widths (e.g., ribbon cartridges 400, 500) in the correct orientation and/or automatically locating each ribbon cartridge in a desired or standardized position for use with a suitable printing device. For example, the ribbon supply spindle 130 of FIGS. 1-3B may be provided in the form of the spindle 200, and the ribbon cartridges 400, 500 may be installed for use with the printer 100.

As shown in FIG. 4, the ribbon cartridge 400 may include a roll of ribbon material 134 defined by a first width W₁. In some instances, the first width W₁ may be imparted with a value of about 107 millimeters (mm) to about 111 mm (or 107 mm to 111 mm). For example, the first width W₁ may be imparted with a value of at least about 107 mm (or at least 107 mm), or at least about 108 mm (or at least 108 mm), or at least about 109 mm (or at least 109 mm), or at least about 110 mm (or at least 110 mm), or at least about 111 mm (or at least 111 mm). In some instances, the first width W₁ may be imparted with a value of 109.2 mm (or about 109.2 mm).

As shown in FIG. 5, the ribbon cartridge 500 may include a roll of ribbon material 134 defined by a second width W₂. The second width W₂ may be smaller or larger than the first width W₁. In some instances, the second width W₂ may be imparted with a value of about 38 mm to about 42 mm (or 38 mm to 42 mm). For example, the second width W₂ may be imparted with a value of at least about 38 mm (or at least 38 mm), or at least about 39 mm (or at least 39 mm), or at least about 40 mm (or at least 40 mm), or at least about 41 mm (or at least 41 mm), or at least about 42 mm (or at least 42 mm). In some instances, the second width W₂ may be imparted with a value of 39.9 mm (or about 39.9 mm).

In some instances, the widths W₁, W₂ of the ribbon cartridges 400, 500, respectively, may correspond to standard sizes for manufacturing ribbon material for thermal transfer printers familiar to those skilled in the art. As explained in detail below, the ribbon cartridge 400, the ribbon cartridge 500, and/or other ribbon cartridges having widths other than the widths W₁, W₂ may each be automatically located in a desired (e.g., central) position with respect to a spindle arm 226 when installed on the spindle 200. Additionally, the spindle 200 and the ribbon cartridges 400, 500 may be configured to ensure that the ribbon cartridges 400, 500 are oriented correctly when installed on the spindle 200 (e.g., in the first, correct orientation shown in FIG. 3A).

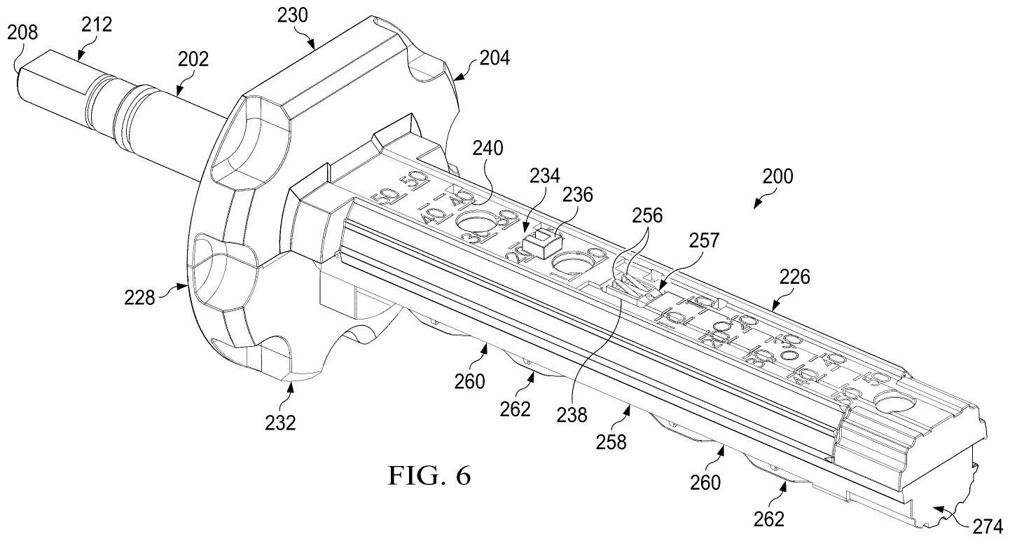

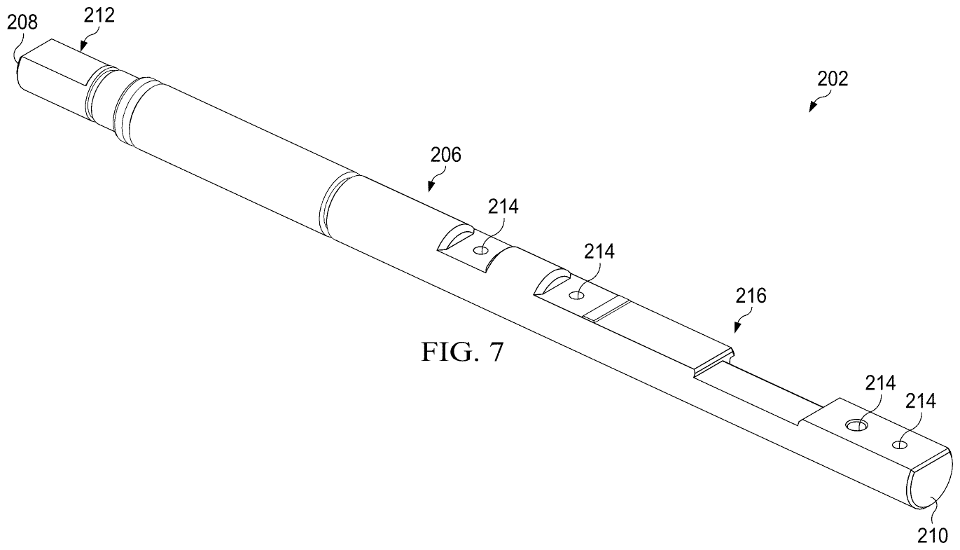

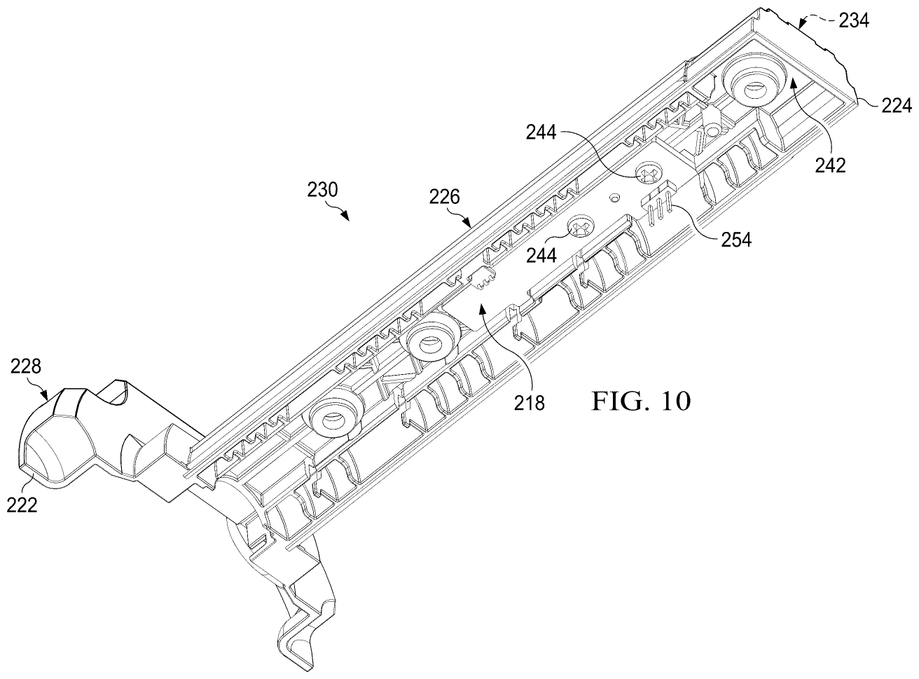

Turning to FIGS. 6-15, the spindle 200 includes a shaft 202 and a hub 204 encasing at least a portion of the shaft 202. As best shown in FIG. 7, the shaft 202 may be provided in the form of a substantially cylindrical shaft body 206 defined by an attachment end 208 and an embedded end 210 opposing the attachment end 208. In some instances, the shaft 202 may include a notched portion 212 positioned proximate to the attachment end 208. The attachment end 208 may be provided in any suitable form designed to facilitate installation of the spindle 200 in a printing device (e.g., the attachment end 208 may be coupled to or extend through an opening in the mounting wall 120 of the printer 100). The shaft 202 may include one or more shaft fastener holes 214 disposed along the shaft body 206 to facilitate, for example, coupling the hub 204 to the shaft 202 when the spindle 200 is assembled. A transmission member bay 216 provided in the form of a stepped, rectilinear recess may be positioned proximate to the embedded end 210 to accommodate a transmission member 218 (see FIG. 10), which may be positioned between the shaft 202 and the hub 204.

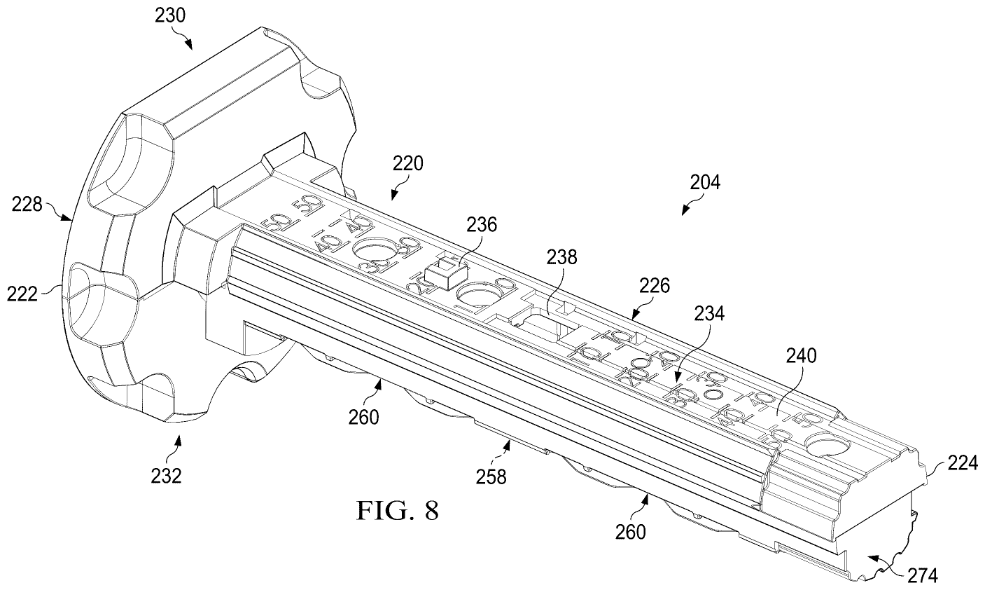

Turning now to FIG. 8, the hub 204 may be provided in the form of a substantially tubular hub body 220 defined by a hub first end 222 and a hub second end 224 opposing the hub first end 222. A spindle arm 226 extending between the hub first end 222 and the hub second end 224 may be configured to receive and retain ribbon cartridges (e.g., ribbon cartridges 400, 500). The spindle arm 226 may be connected to and extend outwardly from a substantially circular spindle flange 228 positioned at the hub first end 222. In some instances, the spindle arm 226 may be formed integrally with the spindle flange 228. In other instances, the spindle arm 226 may be coupled to the spindle flange 228 and extend outwardly therefrom. The spindle arm 226 may be substantially hollow. For example, the spindle arm 226 may be configured to receive the embedded end 210 of the shaft 202 such that a portion of the shaft 202 may be retained therein.

In some instances, the hub body 220 of the hub 204 may be provided as a single, undivided component. In other instances, the hub body 220 may be provided in the form of a first or upper hub portion 230 couplable with a second or lower hub portion 232. In these instances, the upper and lower hub portions 230, 232 may each include a respective portion of the spindle arm 226 and the spindle flange 228.

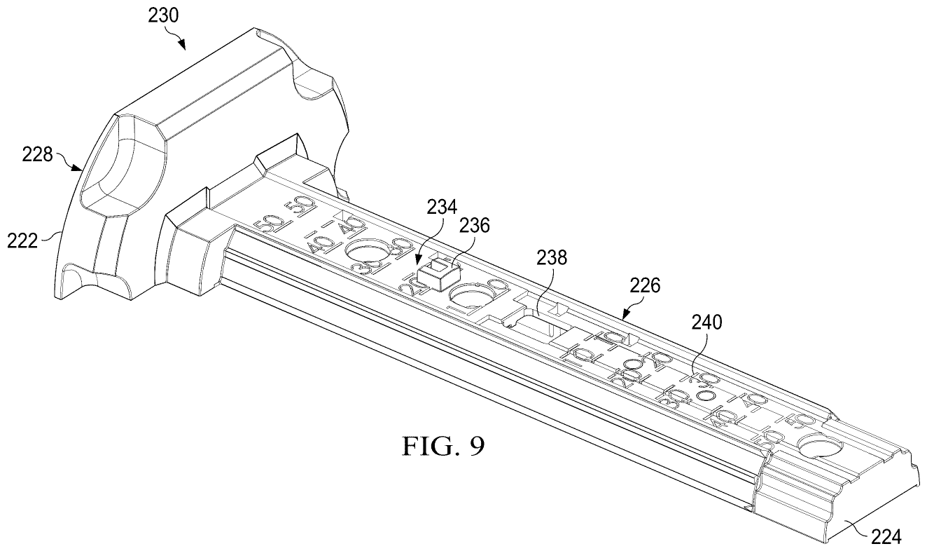

Turning to FIG. 9, the hub 204 may include a spindle mating surface 234 disposed on the upper hub portion 230 and extending between the spindle flange 228 and the hub second end 224. In some instances, the spindle mating surface 234 may be provided in the form of a substantially planar, rectilinear surface having a key 236 disposed therealong and extending away from the spindle mating surface 234 in a direction substantially perpendicular to the spindle mating surface 234. In some instances, the key 236 may be imparted with an angular, U-shaped structure. However, in other instances, the key 236 may be imparted with any suitable shape or structure designed to engage a portion of a ribbon cartridge (e.g., ribbon cartridges 400, 500) and facilitate standardized positioning thereof.

The spindle mating surface 234 may include a contact window 238 provided in the form of a substantially rectilinear opening extending entirely through the upper hub portion 230. In some instances, the contact window 238 may be positioned to align with at least a portion of the transmission member bay 216 of the shaft 202. For example, the contact window 238 may allow a portion of the transmission member 218 positioned between the shaft 202 and the hub 204 to extend beyond the spindle mating surface 234 via the contact window 238 when the spindle 200 is assembled (see FIG. 6).

Additionally, the spindle mating surface 234 may include markings 240 indicative of the distance from a desired (e.g., central) location along the spindle arm 226. In some instances, as shown in FIG. 9, the markings 240 may be labeled with numeric values which begin at zero at the desired location along the spindle arm 226 and increase symmetrically (e.g., 0, 10, 20, 30, 40, 50) (i) between the desired location (e.g., a central point along the spindle arm 226) and the hub first end 222, and (ii) between the desired location (e.g., a central point along the spindle arm 226) and the hub second end 224. In some instances, the markings 240 may allow a user to confirm that a ribbon cartridge (e.g., ribbon cartridges 400, 500) is installed centrally along the spindle arm 226 after being automatically positioned (e.g., centered) on the spindle 200. In other instances, any number of numerical or other markings 240 may be provided along the spindle arm 226 in any suitable arrangement, or the markings 240 may be omitted.

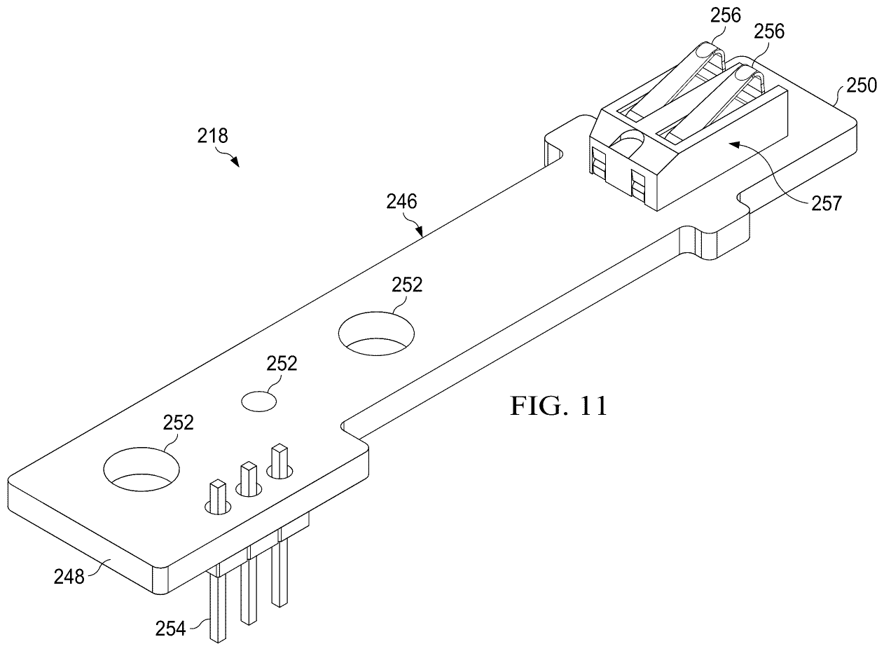

Turning to FIG. 10, the upper hub portion 230 may be configured to receive the transmission member 218. For example, the transmission member 218 may be coupled to an upper hub portion interior surface 242 disposed opposite the spindle mating surface 234 via one or more fasteners 244. In some instances, one or more of the fasteners 244 may be provided in the form of a pin, screw, or any other suitable fastener known in the art. In other instances, one or more of the fasteners 244 may be provided in the form of a protrusion (not shown) on the upper hub portion interior surface 242 such that the protrusion engages a transmission member hole 252 on the transmission member 218 (see FIG. 11) in a snap-fit or friction-fit. The transmission member 218 may be configured to facilitate communication between a ribbon cartridge (e.g., ribbon cartridges 400, 500) and a processor, controller, or other electronic component of a printing device (e.g., the printer 100) when the ribbon cartridge is installed.

As best shown in FIG. 11, the transmission member 218 may be provided in the form of a substantially rectilinear transmission member body 246 defined by a transmission member first end 248 and a transmission member second end 250 opposing the transmission member first end 248. One or more transmission member holes 252 may be disposed along the transmission member body 246 and extend entirely therethrough (e.g., to receive the fasteners 244).

The transmission member 218 may include one or more output contacts 254 and one or more input contacts 256. In some instances, the output contacts 254 may be positioned proximate to the transmission member first end 248 and extend through one or more transmission member holes 252. The input contacts 256 may be positioned on the transmission member body 246 proximate to the transmission member second end 250 and extend upwardly therefrom. In some instances, the input contacts 256 may be positioned on an input contact tab 257 provided in the form of a rectilinear protrusion extending outwardly from the transmission member body 246. For example, the input contact tab 257 may be designed to be received by the contact window 238 of the spindle 200 (see FIG. 8). In other instances, the output contacts 254 and the input contacts 256 may be provided in any suitable form and may be positioned on the transmission member 218 in any suitable arrangement.

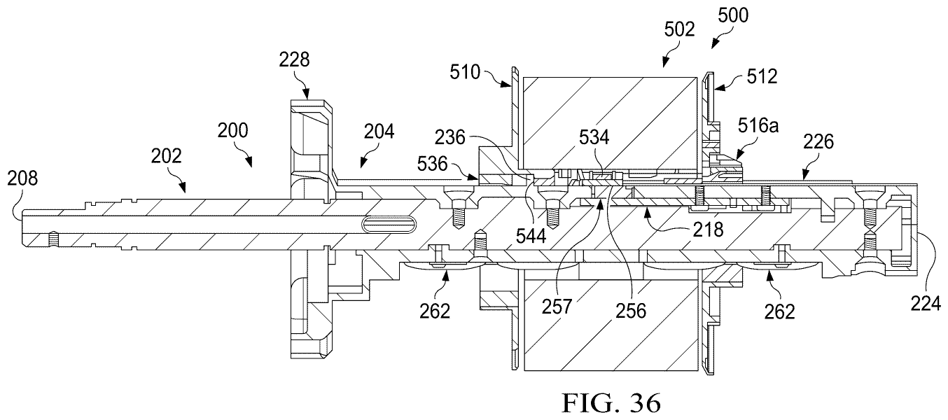

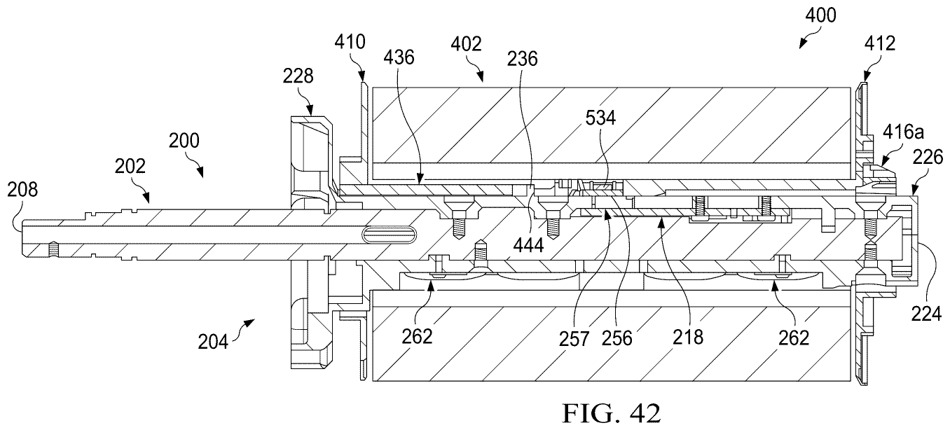

In some instances, the output contacts 254 and input contacts 256 may be in communication with one another. The output contacts 254 may facilitate an electrical connection or communication with a processor, controller, or other electronic component of a printing device (e.g., the printer 100), whereas the input contacts 256 may facilitate an electrical connection or communication with a ribbon cartridge (e.g., ribbon cartridges 400, 500) or a portion thereof. Thus, the transmission member 218 may act as a conduit that allows information to be communicated electronically from the ribbon cartridge to an electronic component of the printing device. For example, when a ribbon cartridge (e.g., ribbon cartridges 400, 500) is installed in the printer 100, a processor or controller of the printer 100 may be configured to detect or receive information about the ribbon cartridge via the transmission member 218, as described in detail below with reference to FIGS. 36 and 42. In some instances, the transmission member 218 may be coupled to the upper hub portion 230 such that the input contacts 256 extend beyond the spindle mating surface 234 via the contact window 238 when the spindle 200 is assembled (see FIG. 6).

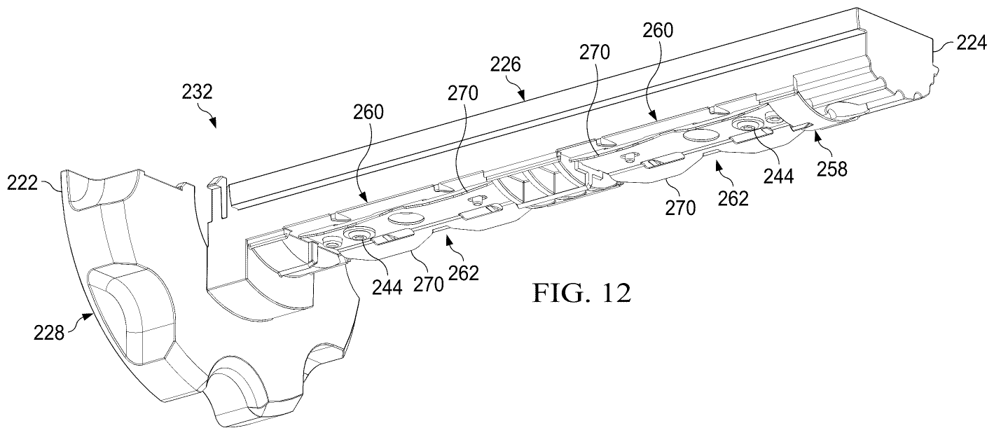

Now turning to FIG. 12, the lower hub portion 232 may include a lower hub portion underside 258 positioned opposite the spindle mating surface 234 and extending between the spindle flange 228 and the hub second end 224. The lower hub portion underside 258 may include one or more attachment zones 260 where one or more leaf springs 262 may be coupled to the lower hub portion 232. For example, in some instances, the lower hub portion 232 may include two attachment zones 260, each of which may receive one leaf spring 262 coupled to the lower hub portion underside 258 by one or more fasteners 244.

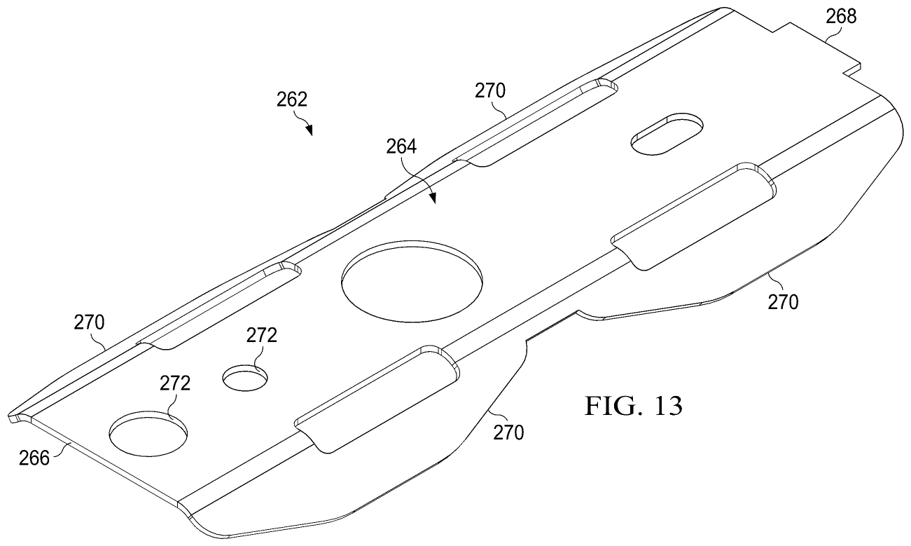

As best shown in FIG. 13, the leaf spring 262 may be provided in the form of a substantially rectangular leaf spring body 264 defined by a leaf spring first end 266 and a leaf spring second end 268 opposing the leaf spring first end 266. The leaf spring 262 may include wings 270 positioned on opposing sides of the leaf spring body 264 and extending between the leaf spring first and second ends 266, 268. In some instances, the leaf spring body 264 may include four wings 270, where two wings 270 are positioned on either side of the leaf spring body 264. The wings 270 may protrude outwardly from and at a downward angle with respect to the leaf spring body 264. One or more leaf spring openings 272 may be disposed along the leaf spring body 264 and extend entirely therethrough, for example, to receive the fasteners 244. Thus, when the leaf spring 262 is coupled to the lower hub portion 232 of the hub 204, the leaf spring body 264 may be substantially flush with the attachment zone 260 and the wings 270 may extend outwardly and at a downward angle therefrom (see FIG. 12). As discussed in more detail below, the wings 270 of the leaf spring 262 may engage with a core of the ribbon cartridges 400, 500 when installed on the spindle 200 to prevent, among other things, the ribbon cartridges from moving out of position when the printer 100 is in use.

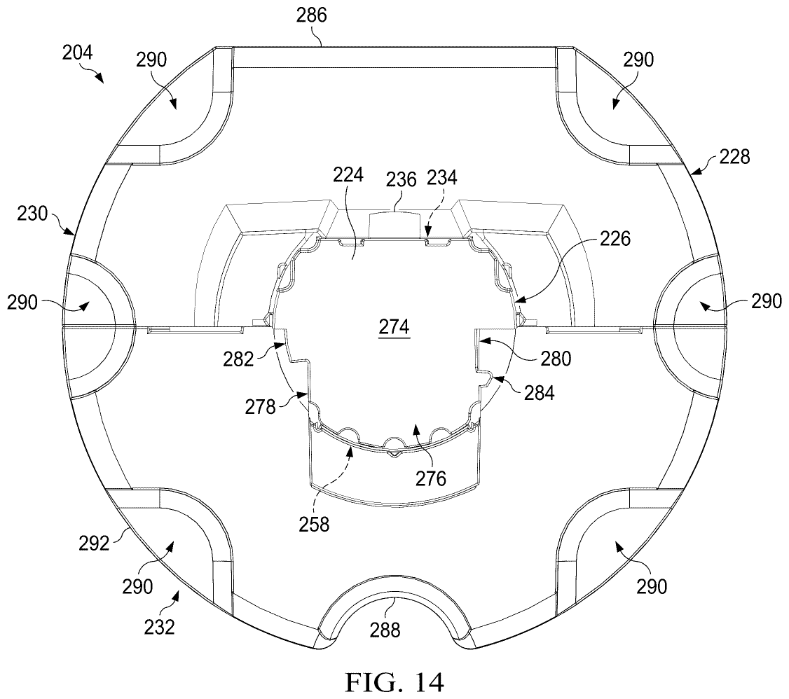

Turning now to FIG. 14, an end face 274 of the spindle arm 226 may be positioned at the hub second end 224. The spindle arm 226 may be substantially translationally symmetrical along the length of the spindle arm 226. In other words, the shape of the end face 274 may be representative of the shape of a cross-section of the spindle arm 226 taken at any point between the spindle flange 228 and the hub second end 224.

In some instances, the spindle arm 226 may be imparted with a substantially T-shaped structure, as reflected by the shape of the end face 274 shown in FIG. 14. For example, the spindle mating surface 234 of the upper hub portion 230 may be positioned atop the T, and the lower hub portion underside 258 may be positioned at the bottom of a base portion 276 of the T (e.g., opposite the spindle mating surface 234). The base portion 276 may include a first spindle side wall 278 and a second spindle side wall 280 opposing the first spindle side wall 278. The first and second spindle side walls 278, 280 may each be oriented in a plane substantially perpendicular to the spindle mating surface 234 and may be substantially parallel to one another.

In some instances, the spindle arm 226 may include a first poka-yoke or fail-safe feature 282 and a second poka-yoke or fail-safe feature 284. The first fail-safe feature 282 may be positioned on the first spindle side wall 278 and protrude outwardly therefrom, and the second fail-safe feature 284 may be positioned on the second spindle side wall 280 and protrude outwardly therefrom. The first and second fail-safe features 282, 284 may be asymmetrically oriented with respect to each other. For example, in some instances, the positioning of the first and second fail-safe features 282, 284 along the first and second spindle side walls 278, 280, respectively, may be offset with respect to each other (e.g., the first fail-safe feature 282 may not be positioned directly opposite the second fail-safe feature 284).

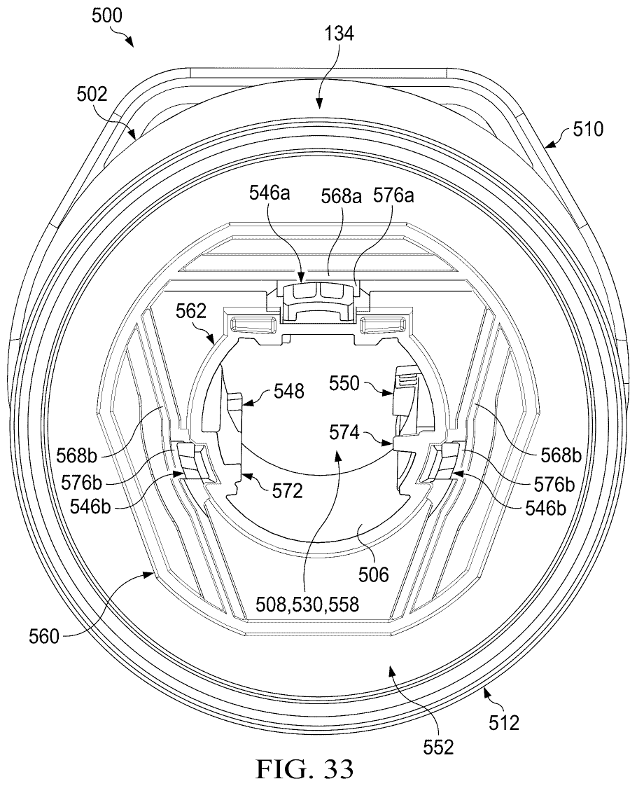

In some instances, the first and second fail-safe features 282, 284 may be provided in the form of a substantially rectilinear railing or protrusion extending along the spindle arm 226 between the spindle flange 228 and the hub second end 224. In other instances, the spindle arm 226 may be imparted with any suitable shape or structure. For example, the spindle arm 226 may include other asymmetrical structural features in addition to or in lieu of the first and second fail-safe features 282, 284, provided that the spindle arm 226 is designed to receive a ribbon cartridge (e.g., ribbon cartridges 400, 500) in the correct orientation (see FIG. 3A) as described in detail below with reference to FIGS. 33-39. For example, the spindle arm 226 may include any number of fail-safe features in addition to or in lieu of the first and second fail-safe features 282, 284, and the first and second fail-safe features may be provided in any suitable form (e.g., keyed features, D-cuts, or any other feature known in the art to facilitate correct installation and/or restrict incorrect installation of a ribbon cartridge). The first and second fail-safe features 282, 284 (and/or other fail-safe features not specifically described herein) may each be imparted with a different shape, size, and/or other characteristic relative to one another. In some instances, the first and second fail-safe features 282, 284 may be positioned at the hub second end 224 and may not extend along a length of the spindle arm 226.

Still referring to FIG. 14, in some instances, the spindle flange 228 may be imparted with a substantially circular profile. In some instances, the upper hub portion 230 may include a spindle flange upper edge 286, which may be substantially flat and oriented in a plane substantially parallel to the spindle mating surface 234. In some instances, the lower hub portion 232 may include a semicircular notch 288 that is positioned opposite the spindle flange upper edge 286. In some instances, one or more rounded spindle flange indentations 290 may be disposed about a spindle flange outer perimeter 292. The spindle flange indentation 290 may be provided to facilitate removal of a ribbon cartridge (e.g., ribbon cartridges 400, 500) from the spindle 200 (e.g., by aiding a user in gripping the ribbon cartridge such that the user can pull or remove the ribbon cartridge from the spindle 200). In other instances, the spindle flange 228 may be imparted with any suitable shape or structure. For example, the spindle flange 228 may be designed to facilitate engagement with one or more components of a desired ribbon cartridge (e.g., ribbon cartridges 400, 500) or with one or more internal components of a desired printing device (e.g., the printer 100).

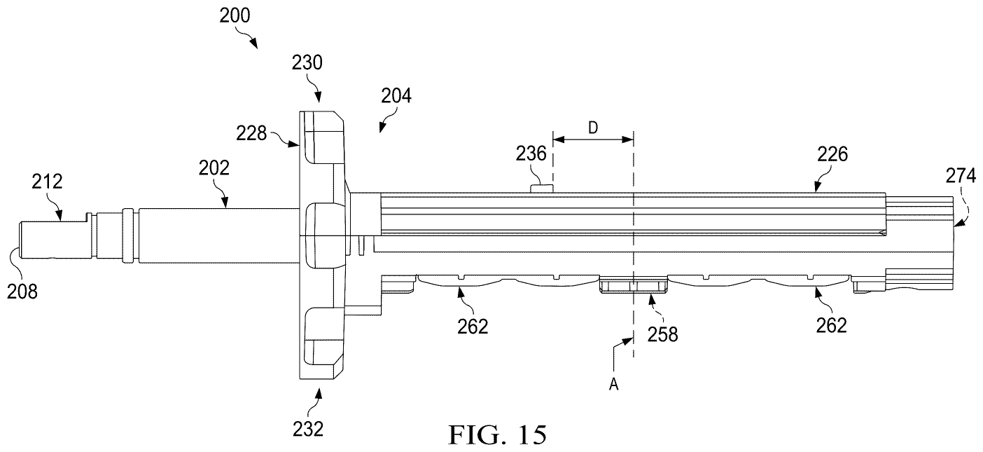

Turning to FIG. 15, in some instances, the key 236 may be positioned a standardized distance D away from a central axis A of the spindle arm 226. The axis A may be substantially perpendicular with respect to the lower hub portion underside 258 and may extend through a central location along the spindle arm 226. In some instances, the axis A may correspond to a central position within a desired printing device (e.g., the printer 100). The distance D may be imparted with a value of about 14 mm to about 21 mm (or 14 mm to 21 mm). In some instances, the distance D may be imparted with a value of at least about 14 mm (or at least 14 mm), or at least about 15 mm (or at least 15 mm), or at least about 16 mm (or at least 16 mm), or at least about 17 mm (or at least 17 mm), or at least about 18 mm (or at least 18 mm), or at least about 19 mm (or at least 19 mm) or at least about 20 mm (or at least 20 mm), or at least about 21 mm (or at least 21 mm). In some instances, the distance D may be imparted with a value of about 17 mm to about 18 mm (or 17 mm to 18 mm). In some instances, the distance D may be imparted with a value of 17.7 mm (or about 17.7 mm).

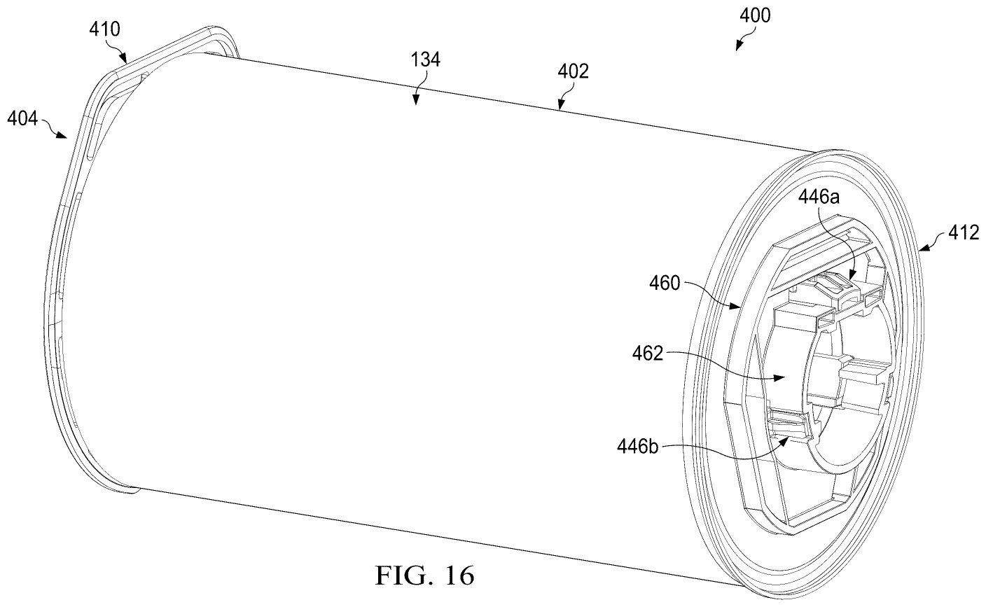

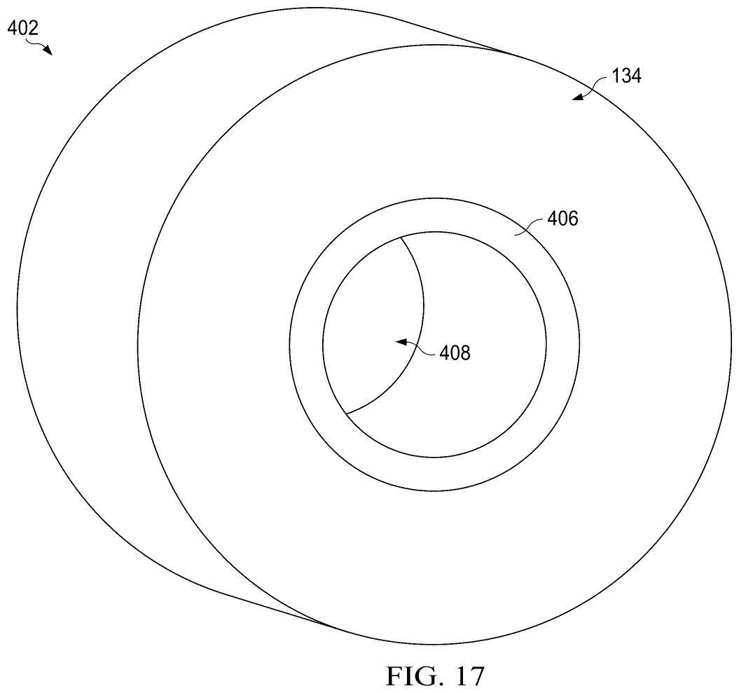

Turning now to FIGS. 16-25, the ribbon cartridge 400 may include a ribbon roll 402 retained by or installed on a ribbon holder 404. As best shown in FIG. 17, the ribbon roll 402 may include a cylindrical core 406 and a supply of ribbon material 134 wound about the core 406. The core 406 may be provided in the form of a cylindrical piece of cardboard, plastic, or other suitable material defining a core opening 408 extending therethrough. The ribbon material 134 may be provided in the form of a strip of thin film having one side coated with ink. For example, the ink may be made of wax, resin, a combination thereof, or other compounds or substances known in the art. As previously mentioned, the supply of ribbon material 134 of the ribbon cartridge 400 may be defined by the first width W₁ (see FIG. 4).

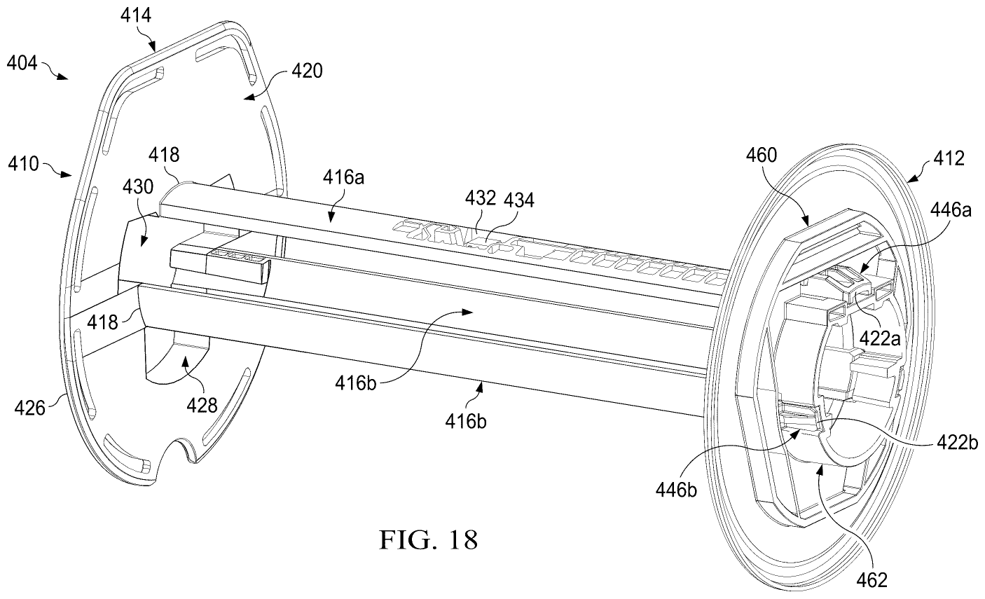

As shown in FIG. 18, the ribbon holder 404 may include a support member 410 configured to receive the ribbon roll 402 and an end cap 412 couplable to the support member 410. The support member 410 may be provided in the form of a substantially circular cartridge flange 414 and one or more arms 416 connected to the cartridge flange 414 and extending outwardly therefrom. For example, an arm first end 418 may be formed integrally with or may be coupled to the cartridge flange 414 via a cartridge flange interior surface 420, and the arms 416 may extend outwardly therefrom. The arms 416 may be oriented substantially perpendicular to the cartridge flange interior surface 420. Each arm 416 may include an arm second end 422 positioned opposite the arm first end 418 and configured to engage the end cap 412 (e.g., facilitating coupling between the support member 410 and the end cap 412).

In some instances, the support member 410 may have three arms 416 including one central arm 416a and two side arms 416b. The central arm 416a may be configured to engage the key 236 of the hub 204 when the ribbon cartridge 400 is installed on the spindle 200. The side arms 416b may be configured to further support the ribbon roll 402 and/or to provide stability and structural rigidity to the ribbon holder 404.

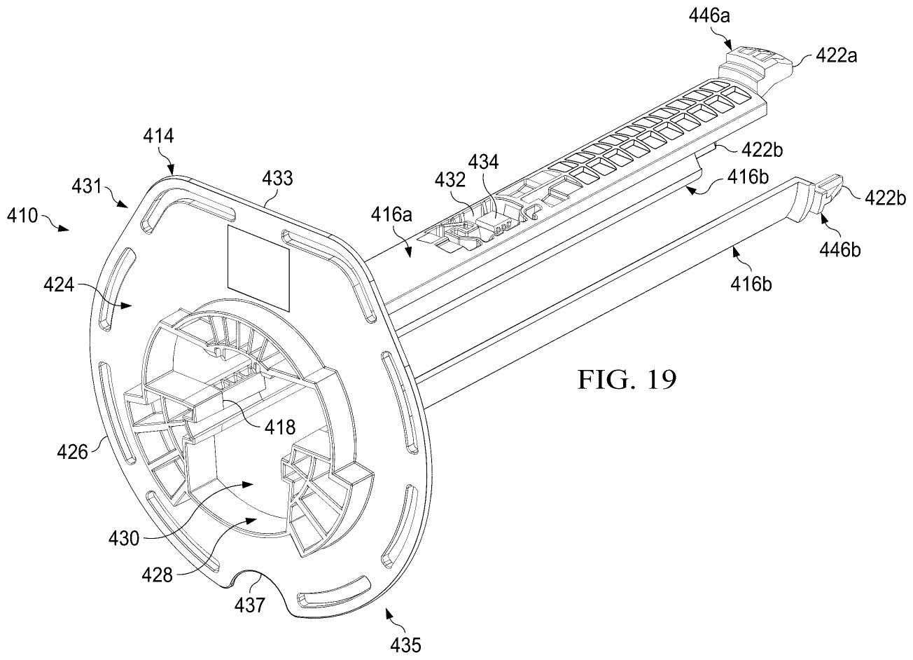

Turning to FIG. 19, the cartridge flange 414 may be provided in the form of a cartridge flange body 424 defined by a cartridge flange exterior perimeter 426 and a cartridge flange interior surface 428. The cartridge flange interior surface 428 may define a support member opening 430 extending entirely through the cartridge flange body 424. In some instances, the cartridge flange interior surface 428 may be substantially T-shaped. In some instances, the cartridge flange exterior perimeter 426 may be substantially circular. In other instances, a cartridge flange top portion 431 may include a cartridge flange top edge 433, which may be substantially flat. The cartridge flange top edge 433 may be designed to align with the spindle flange upper edge 286 when the ribbon cartridge 400 is installed correctly. For example, the cartridge flange top edge 433 may have the same shape as the spindle flange upper edge 286 (e.g., substantially flat) to visually assist the user in positioning the ribbon cartridge 400 on the spindle 200 with the correct orientation (e.g., by aligning the cartridge flange top edge 433 with the spindle flange upper edge 286 when installing the ribbon cartridge 400 on the spindle 200). In other instances, the spindle flange 424 may be imparted with any suitable shape or structure.

In some instances, a cartridge flange bottom portion 435 may include a semicircular cartridge flange notch 437 that is positioned opposite the cartridge flange top edge 433. The arm first end 418 may be coupled to or positioned adjacent to the cartridge flange interior surface 428 and extend linearly away therefrom. Thus, the support member opening 430 and the arms 416 may together define a substantially tubular space configured to receive the spindle arm 226 when the ribbon cartridge 400 is installed on the spindle 200.

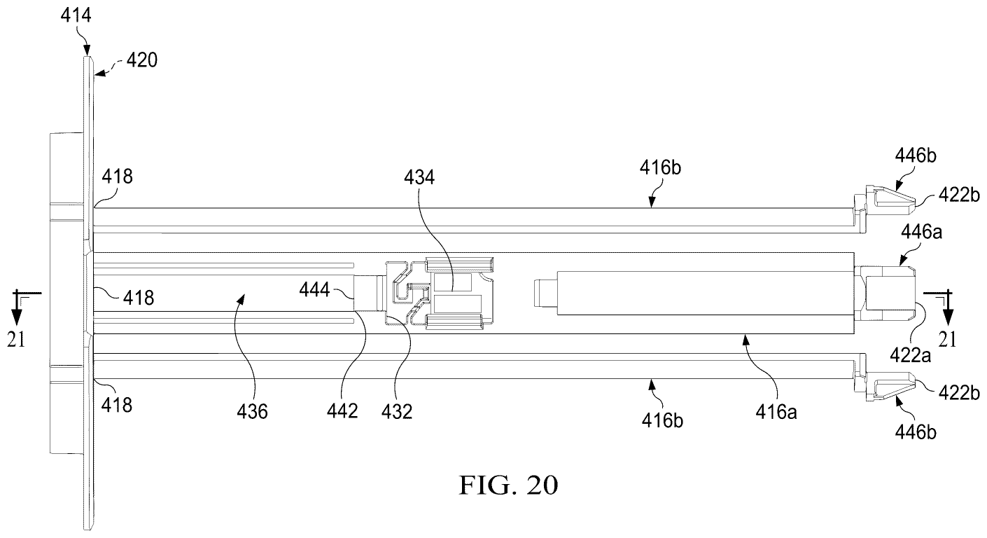

Turning to FIG. 20, in some instances, the central arm 416a may include a smart cell bay 432 provided in the form of a substantially rectilinear opening extending therethrough. The smart cell bay 432 may be configured to retain or support a smart cell 434. In some instances, the smart cell 434 may be provided in the form of a storage or memory device containing preprogrammed information about the ribbon cartridge 400. For example, the smart cell 434 may store information concerning the ribbon width, ribbon type, ribbon color, roll length, and/or other information about the ribbon cartridge 400 and/or its contents. Additionally, the smart cell 434 may include a preprogrammed electronic authentication signal indicating that the ribbon cartridge 400 is intended for use with the spindle 200 or with a particular printing device (e.g., the printer 100). The smart cell 434 may contact the input contacts 256 (see FIG. 6) when the ribbon cartridge 400 is installed on the spindle 200 such that the printing device (e.g., the printer 100) may read or receive the information stored in the smart cell 434.

A keyway 436 positioned on the support member 410 may be configured to align with and engage the key 236 of the hub 204 when the ribbon cartridge 400 is installed on the spindle 200. For example, the keyway 436 may be provided in the form of a substantially rectangular channel positioned on a cartridge mating surface 438. In some instances, the cartridge mating surface 438 is provided on an underside of the central arm 416a and arranged to be flush with or positioned adjacent to the spindle mating surface 234 when the ribbon cartridge 400 is installed. The keyway 436 may be imparted with dimensions that complement or are substantially similar to the dimensions of the key 236. For example, the keyway 436 may be configured to securely receive the key 236 such that rotational motion of the support member 410 with respect to the spindle 200 is eliminated or reduced.

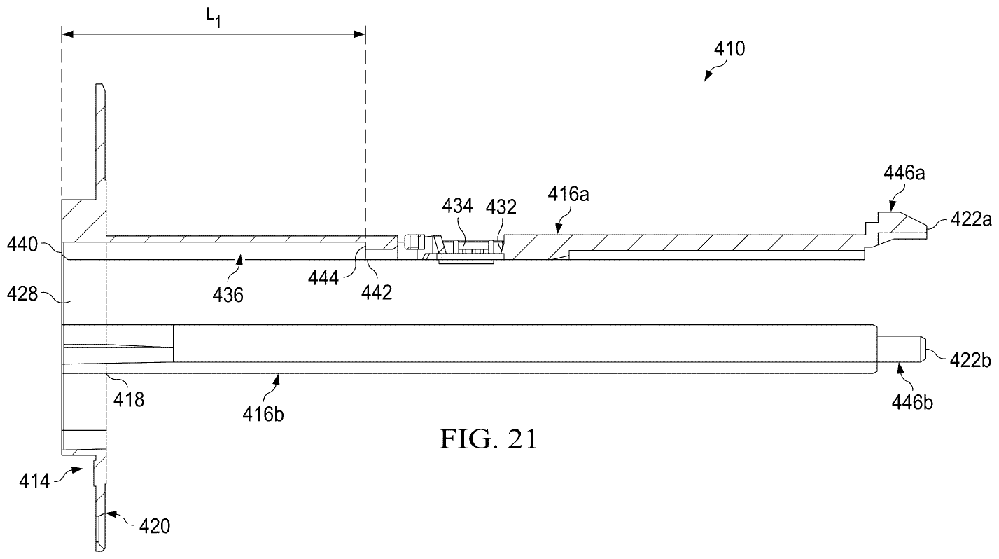

As best shown in the cross-sectional view of FIG. 21, the keyway 436 may extend from a keyway proximal end 440 located on the cartridge flange interior surface 428 and terminate at a keyway terminal end 442 positioned along the central arm 416a between the cartridge flange 414 and the smart cell bay 432. Thus, the keyway 436 of the ribbon cartridge 400 may be defined by a first length L₁ measured linearly between the keyway proximal end 440 and the keyway terminal end 442. A substantially vertical keyway end wall 444 arranged to impact or otherwise engage the key 236 may be positioned at the keyway terminal end 442.

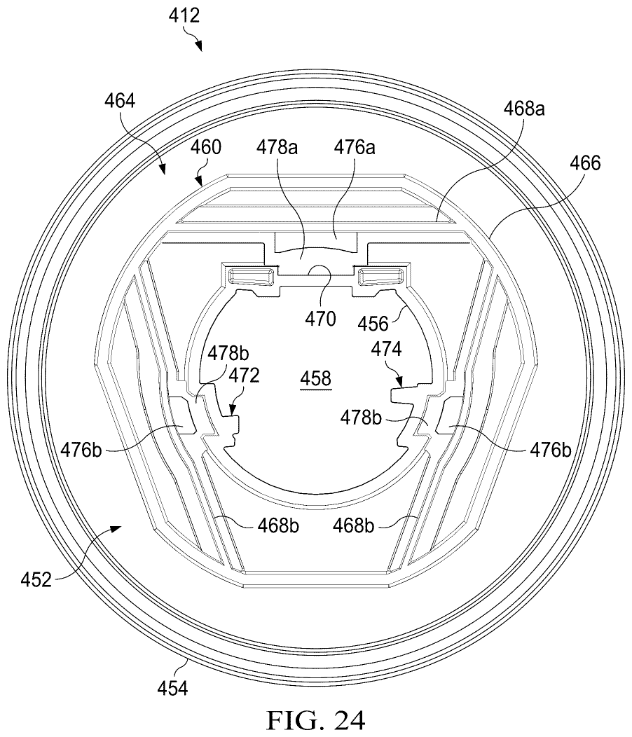

As best shown in FIGS. 19 and 20, each arm 416 may include a connector 446 positioned at the arm second end 422. The connectors 446 may be configured to be received by the end cap 412 and facilitate coupling between the support member 410 and the end cap 412. In some instances, the connectors 446 may be provided in the form of substantially rectilinear, stepped protrusions positioned at the arm second end 422a of the central arm 416a and the arm second end 422b of each of the side arms 416b. In some instances, each connector 446a, 446b may be provided in substantially the same form. In other instances, the connector 446a of the central arm 416a may be imparted with a different size, shape, or structure than the connectors 446b of the side arms 416b. In still other instances, each connector 446a, 446b may be provided in any suitable form so long as the connectors 446 are configured to facilitate coupling between the support member 410 and the end cap 412 as described in detail below with reference to FIG. 24.

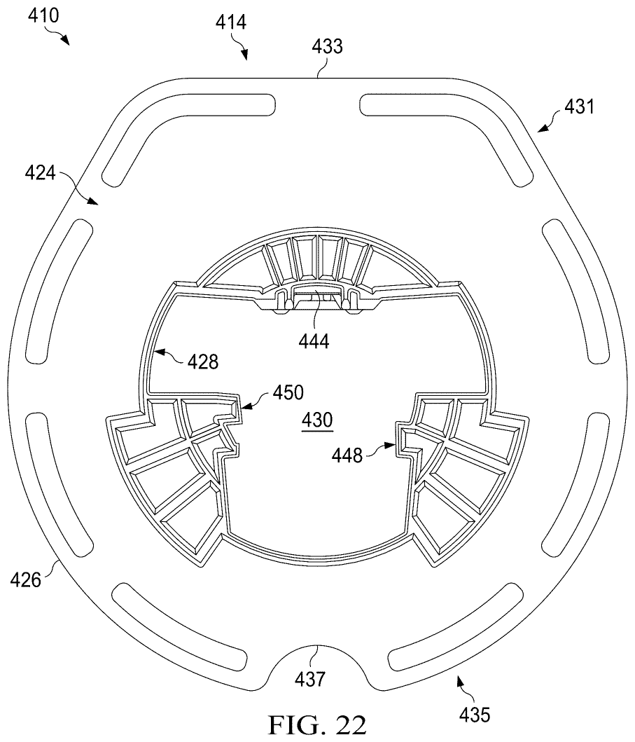

Turning to FIG. 22, the support member 410 may include a first poka-yoke or fail-safe member 448 and a second poka-yoke or fail-safe member 450 disposed about the support member opening 430 of the cartridge flange 414 and protruding inwardly therefrom (e.g., into the support member opening 430). In some instances, the first and second fail-safe members 448, 450 may be provided in the form of rectilinear or curvilinear protrusions positioned on the cartridge flange interior surface 428. In other instances, the first and second fail-safe members 448, 450 may be provided in any suitable form provided that engagement between the first and second fail-safe members 448, 450 and the first and second fail-safe features 282, 284, respectively, of the spindle arm 226 facilitates correct installation of the ribbon cartridge 400. As shown, the support member opening 430 may be substantially T-shaped (e.g., mirroring the shape of the spindle arm 226). Thus, the first and second fail-safe members 448, 450 may be provided in the form of asymmetrical protrusions located along the cartridge flange interior surface 428 and positioned opposite from one another.

In some instances, the positioning of the first and second fail-safe members 448, 450 on the cartridge flange interior surface 428 may correspond to or complement the positioning of the first and second fail-safe features 282, 284 of the spindle arm 226. For example, the first and second fail-safe members 448, 450 may be configured such that the first fail-safe member 448 may be adjacent to but move freely past the first fail-safe feature 282 and the second fail-safe member 450 may be adjacent to but move freely past the second fail-safe feature 284 when the support member 410 is installed on the spindle arm 226 (e.g., as a component part of the ribbon cartridge 400) in the correct orientation (see FIG. 3A). On the other hand, if an attempt is made to install the ribbon cartridge 400 on the spindle arm 226 in the incorrect orientation (see FIG. 3B), the first fail-safe member 448 may impact the second fail-safe feature 284 and/or the second fail-safe member 450 may impact the first fail-safe feature 282, thereby preventing installation.

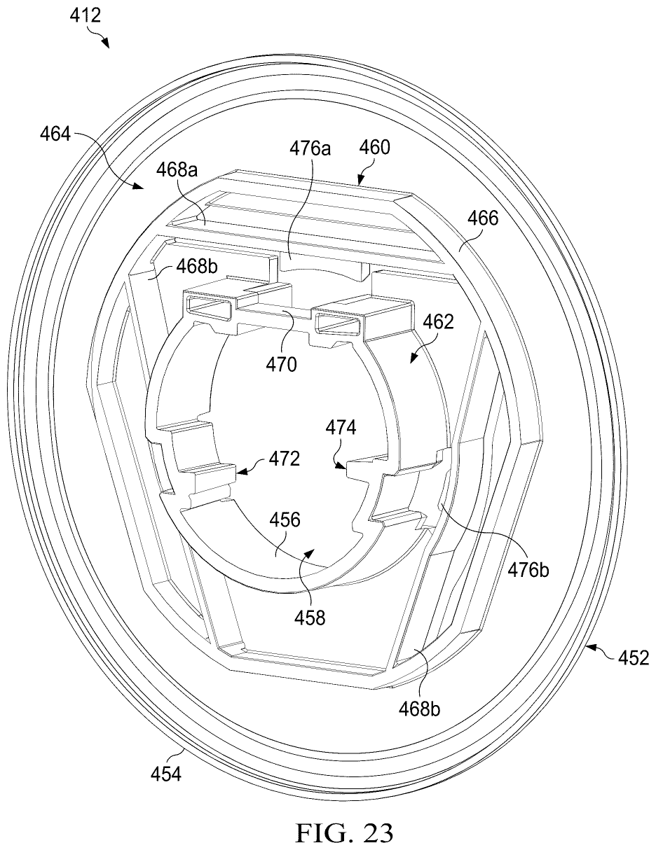

Turning now to FIGS. 23 and 24, the end cap 412 may be provided in the form of an end cap body 452 defined by an end cap exterior perimeter 454. In some instances, the end cap exterior perimeter 454 may be substantially circular. In other instances, the end cap 412 may be imparted with any suitable shape or structure (e.g., to accommodate rolls of ribbon material 134 having different sizes or widths). In some instances, the end cap 412 may include a substantially circular or irregularly shaped end cap interior surface 456 defining a central end cap opening 458 extending entirely through the end cap body 452. For example, the end cap opening 458 may be configured to receive a portion of the spindle 200 when the ribbon cartridge 400 is installed.

As best shown in FIG. 23, a substantially ring-shaped support structure 460 and a central collar 462 may be positioned on an exterior face 464 of the end cap 412 and protrude outwardly therefrom. The support structure 460 may include a substantially ring-shaped outer wall 466 and one or more substantially linear panels 468. Each panel 468 may be either formed integrally with or coupled to the outer wall 466 and may extend between two points along the outer wall 466. In some instances, the support structure 460 may have three panels 468 including one central panel 468a and two side panels 468b (e.g., configured to correspond to the central arm 416a and the two side arms 416b, respectively). The support structure 460 may, for example, provide stability and/or structural rigidity to the end cap 412, the ribbon holder 404 in general, and/or other components of the ribbon cartridge 400.

Turning to FIG. 24, the central collar 462 may be imparted with a substantially circular profile. However, the central collar 462 may include a substantially linear collar upper edge 470 positioned proximate to and oriented substantially parallel with respect to the central panel 468a. Additionally, the central collar 462 may include a third poka-yoke or fail-safe member 472 and a fourth poka-yoke or fail-safe member 474, each positioned along the end cap interior surface 456 adjacent to one of the side panels 468b. Thus, the central collar 462 and the end cap opening 458 defined by the central collar 462 may be imparted with a shape and structure that complements and/or mirrors that of the spindle arm 226 as described above with reference to FIG. 14.

The third and fourth fail-safe members 472, 474 of the end cap 412 may function in a manner similar to that of the first and second fail-safe members 448, 450 of the support member 410, as described above with reference to FIG. 22. For example, the third and fourth fail-safe members 472, 474 may be configured such that, when the end cap 412 is installed on the spindle arm 226 (e.g., as a component part of the ribbon cartridge 400) in the correct orientation, the third fail-safe member 472 may be adjacent to but move freely past the first fail-safe feature 282 and the fourth fail-safe member 474 may be adjacent to but move freely past the second fail-safe feature 284. On the other hand, if an attempt is made to install the ribbon cartridge 400 on the spindle arm 226 in the incorrect orientation, the third fail-safe member 472 may impact the second fail-safe feature 284 and the fourth fail-safe member 474 may impact the first fail-safe feature 282, thereby preventing installation.

In some instances, the third and fourth fail-safe members 472, 474 may be provided in the form of rectilinear or curvilinear protrusions positioned on the end cap interior surface 456. In other instances, the third and fourth fail-safe members 472, 474 may be provided in any suitable form provided that engagement between the third and fourth fail-safe members 472, 474 and the first and second fail-safe features 282, 284 of the spindle arm 226 facilitates correct installation of the ribbon cartridge 400.

Referring still to FIG. 24, the end cap 412 may include one or more connection tabs 476 configured to enable coupling between the end cap 412 and the support member 410 by receiving and/or engaging the connectors 446 of the arms 416. In some instances, the end cap 412 may include a central connection tab 476a and two side connection tabs 476b. For example, the central connection tab 476a may be formed integrally with or connected to the central panel 468a and extend inwardly therefrom (e.g., toward the collar upper edge 470). A connector opening 478a positioned between the central connection tab 476a and the collar upper edge 470 may be configured to permit the connector 446 of the central arm 416a to pass therethrough and to releasably engage the central connection tab 476a. One side connection tab 476b may be formed integrally with or connected to the side panel 468b proximate to the third fail-safe member 472 and extend inwardly therefrom. A connector opening 478b positioned between the side connection tab 476b and the third fail-safe member 472 may be configured to permit the connector 446 of one of the side arms 416b to pass therethrough and to releasably engage the side connection tab 476b. The other side connection tab 476b may be formed integrally with or connected to the side panel 468b proximate to the fourth fail-safe member 474 and extend inwardly therefrom. A connector opening 478b positioned between the side connection tab 476b and the fourth fail-safe member 474 may be configured to permit the connector 446 of the other side arm 416b to pass therethrough and to releasably engage the side connection tab 476b.

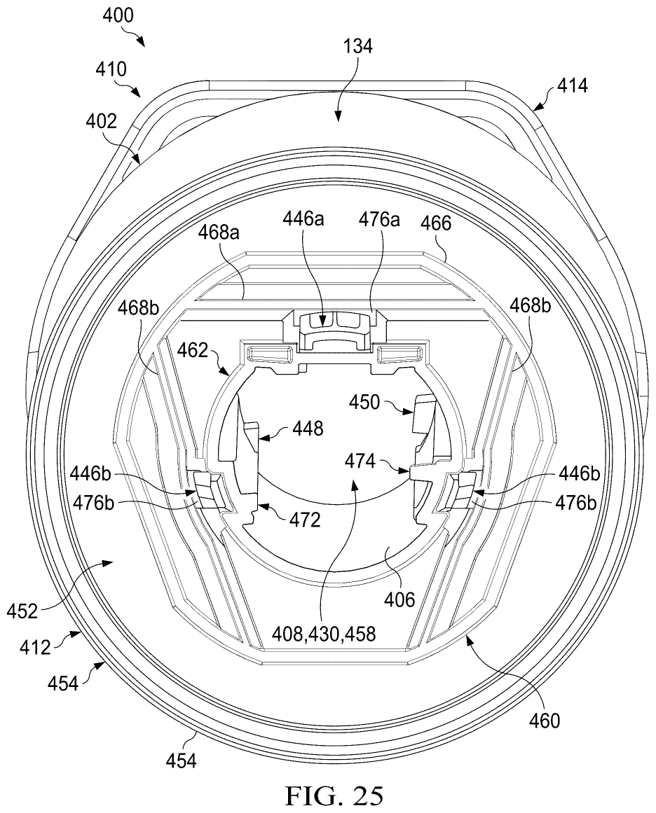

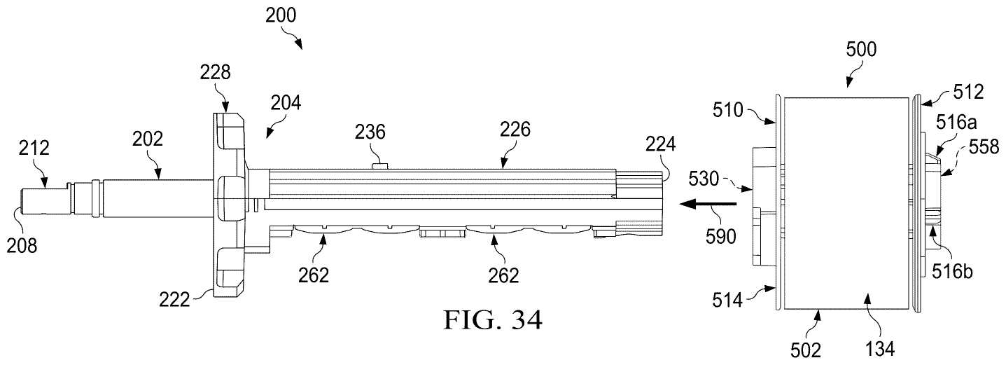

Thus, as shown best in FIG. 25, the engagement between the connectors 446 and the connection tabs 476 may releasably couple the end cap 412 to the support member 410, and the ribbon roll 402 may be retained between the end cap 412 and the cartridge flange 414 of the support member 410. When the ribbon cartridge 400 is assembled, the arms 416 may extend through the core 406 of the ribbon roll 402. In some instances, the support member 410 may be configured to engage (e.g., stabilize) the core 406 via friction or outward pressure applied by the arms 416. The core opening 408 of the ribbon roll 402, the support member opening 430, and the end cap opening 458 may align and provide a passageway extending through the ribbon cartridge 400 configured to receive the spindle arm 226. Additionally, the third and fourth fail-safe members 472, 474 of the end cap 412 may align with the first and second fail-safe members 448, 450 of the support member 410, respectively. In this way, the ribbon cartridge 400 may be biased toward installation with the correct orientation (e.g., the ribbon cartridge may be restricted from being installed with the incorrect orientation) as explained below with reference to FIGS. 34-39.

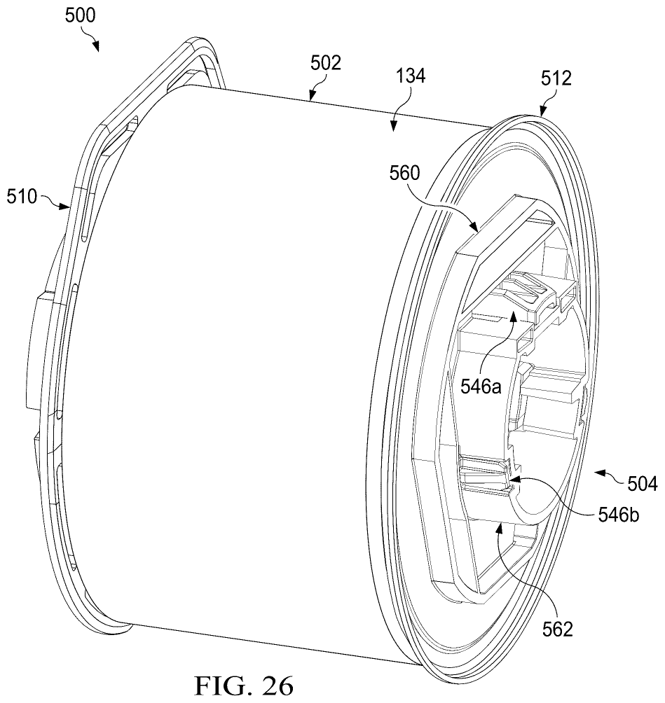

Turning now to FIGS. 26-33, another embodiment of a ribbon cartridge 500 is depicted and may be provided in substantially the same form as the ribbon cartridge 400. However, as described above with reference to FIGS. 4 and 5, the ribbon cartridge 500 may retain a supply of ribbon material 134 having a different width (e.g., the second width W₂) compared to the ribbon cartridge 400. In describing the ribbon cartridge 500, like names and like reference numerals are used to refer to like parts with respect to the ribbon cartridge 400. In particular, components of the ribbon cartridge 500 and components of the ribbon cartridge 400 labeled with similar or identical names and reference numerals having a difference of exactly 100 may be substantially similar in both form and function.

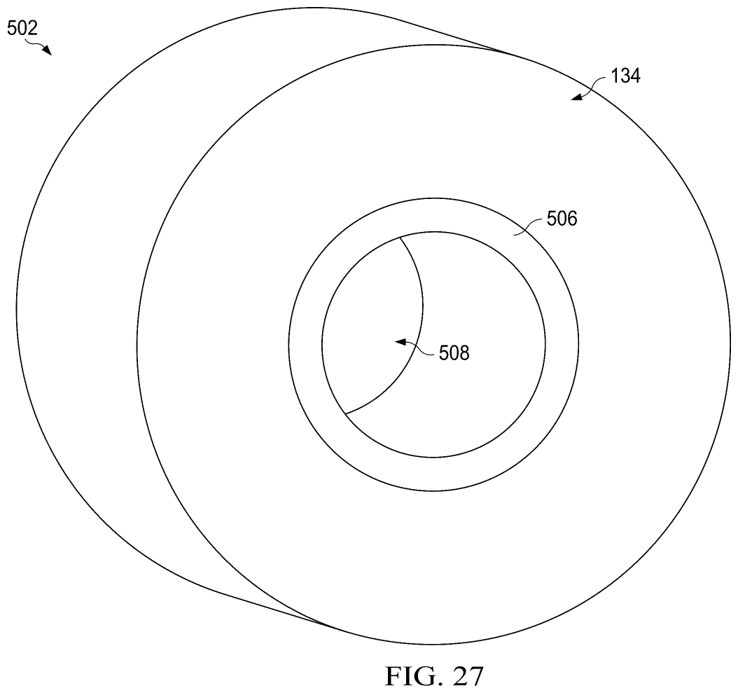

As shown in FIGS. 26 and 27, the ribbon cartridge 500 may include a ribbon roll 502 retained by or installed on a ribbon holder 504. As best shown in FIG. 27, the ribbon roll 502 may include a cylindrical core 506 and a supply of ribbon material 134 wound about the core 506. The core 506 may define a substantially cylindrical core opening 508 extending entirely therethrough. As previously discussed with respect to FIG. 5, the supply of ribbon material 134 of the ribbon cartridge 500 may be defined by the second width of W₂.

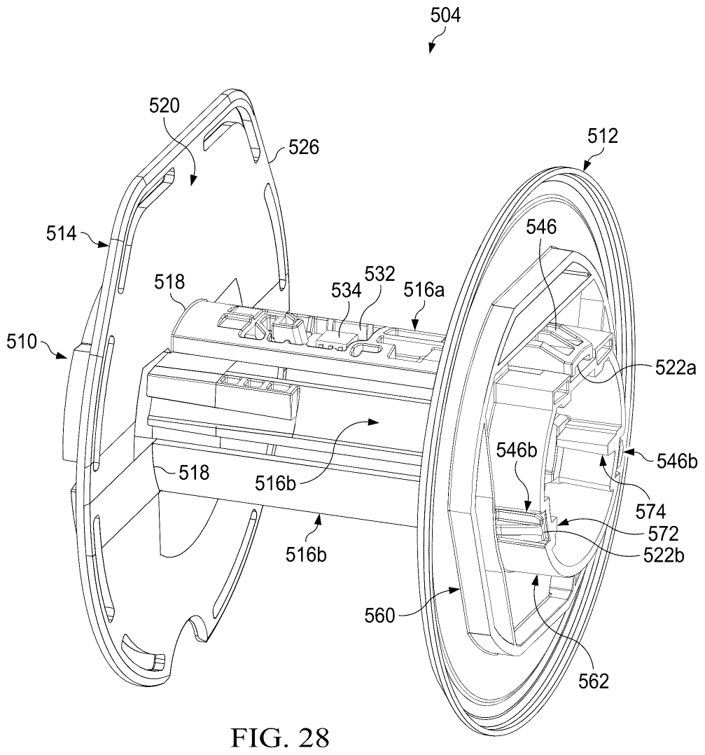

Turning to FIG. 28, the ribbon holder 504 may include a support member 510 configured to receive the ribbon roll 502 and an end cap 512 which can be releasably coupled to an end of the support member 510. The support member 510 may be provided in the form of a substantially circular cartridge flange 514 and one or more arms 516 connected to the cartridge flange 514 and extending outwardly therefrom. For example, an arm first end 518 of each arm 516 may be formed integrally with or may be coupled to a cartridge flange interior surface 520. The arms 516 may extend linearly away from the cartridge flange 514 such that the arms 516 are oriented in a plane substantially perpendicular to the cartridge flange interior surface 520. An arm second end 522 of each arm 516 may engage the end cap 512 thereby coupling the support member 510 and the end cap 512. In some instances, the arms 516 may include one central arm 516a and two side arms 516b. The central arm 516a may be configured to engage the key 236 of the hub 204 when the ribbon cartridge 500 is installed on the spindle 200. The side arms 516b may be configured to further support the ribbon roll 502 and/or to provide stability and structural rigidity to the ribbon holder 404.

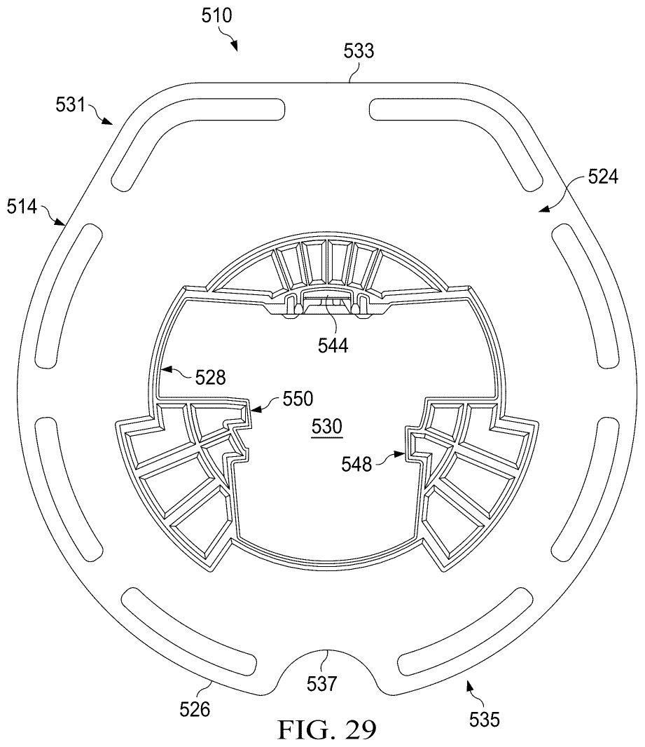

As shown best in FIG. 29, the cartridge flange 514 may be provided in the form of a cartridge flange body 524 defined by a cartridge flange exterior perimeter 526 and a cartridge flange interior surface 528. The cartridge flange interior surface 528 may define a support member opening 530 extending entirely through the cartridge flange body 524. In some instances, the cartridge flange interior surface 528 may be substantially T-shaped. In some instances, the cartridge flange exterior perimeter 526 may be substantially circular. In other instances, a cartridge flange top portion 531 of the cartridge flange body 524 may include a cartridge flange top edge 533, which may be substantially flat. The cartridge flange top edge 533 may be designed to align with the spindle flange upper edge 286 when the ribbon cartridge 500 is installed correctly. In some instances, the cartridge flange top edge 533 may have the same shape as the spindle flange upper edge 286 (e.g., substantially flat) to visually assist the user in positioning the ribbon cartridge 500 on the spindle 200 with the correct orientation (e.g., by aligning the cartridge flange top edge 533 with the spindle flange upper edge 286 when installing the ribbon cartridge 500 on the spindle 200). In some instances, a cartridge flange bottom portion 535 of the cartridge flange body 524 may include a semicircular cartridge flange notch 537 that is positioned opposite the cartridge flange top edge 533.

The support member 510 may include a first poka-yoke or fail-safe member 548 and a second poka-yoke or fail-safe member 550 disposed about the cartridge flange interior surface 528 and protruding inwardly therefrom (e.g., into the support member opening 530). In some instances, the first and second fail-safe members 548, 550 may be provided in the form of rectilinear protrusions positioned on the cartridge flange interior surface 528. In other instances, the first and second fail-safe members 548, 550 may be provided in any suitable form provided that engagement between the first and second fail-safe members 548, 550 and the first and second fail-safe features 282, 284, respectively, of the spindle arm 226 facilitates correct installation of the ribbon cartridge 500.

In some instances, the positioning of the first and second fail-safe members 548, 550 on the cartridge flange interior surface 528 may correspond to or complement the positioning of the first and second fail-safe features 282, 284 of the spindle arm 226, respectively. For example, the first and second fail-safe members 548, 550 may be configured such that the first fail-safe member 548 may be adjacent to but move freely past the first fail-safe feature 282 and the second fail-safe member 550 may be adjacent to but move freely past the second fail-safe feature 284 when the support member 510 is installed on the spindle arm 226 (e.g., as a component part of the ribbon cartridge 500) in the correct orientation (see FIG. 3A). On the other hand, if an attempt is made to install the ribbon cartridge 500 on the spindle arm 226 in the incorrect orientation (see FIG. 3B), the first fail-safe member 548 may impact the second fail-safe feature 284 and/or the second fail-safe member 550 may impact the first fail-safe feature 282, thereby preventing installation.

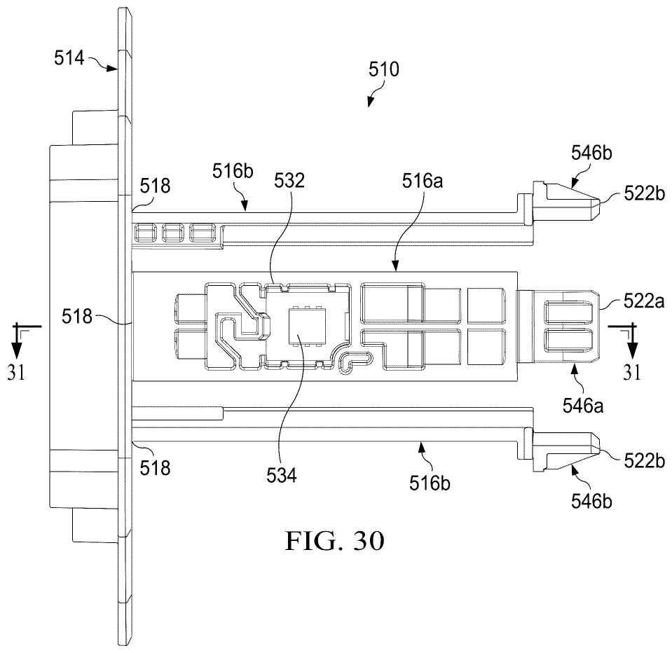

Turning to FIG. 30, the support member 510 may include a smart cell 534. In some instances, the central arm 516a may include a smart cell bay 532 provided in the form of a substantially rectilinear opening extending entirely through the central arm 516a and configured to receive and retain the smart cell 534. In some instances, the smart cell 534 may be provided in the form of a storage or memory device containing preprogrammed information about the ribbon cartridge 500. For example, the smart cell 534 may store information concerning the ribbon width, ribbon type, ribbon color, roll length, and/or other information about the ribbon cartridge 500 and/or its contents. Additionally, the smart cell 534 may include a preprogrammed electronic authentication signal indicating that the ribbon cartridge 500 is intended for use with the spindle 200 or with a particular printing device (e.g., the printer 100). The smart cell 534 may contact the input contacts 256 of the transmission member 218 (see FIG. 6) when the ribbon cartridge 500 is installed on the spindle 200 such that the printing device (e.g., the printer 100) may read or receive the information stored in the smart cell 534.

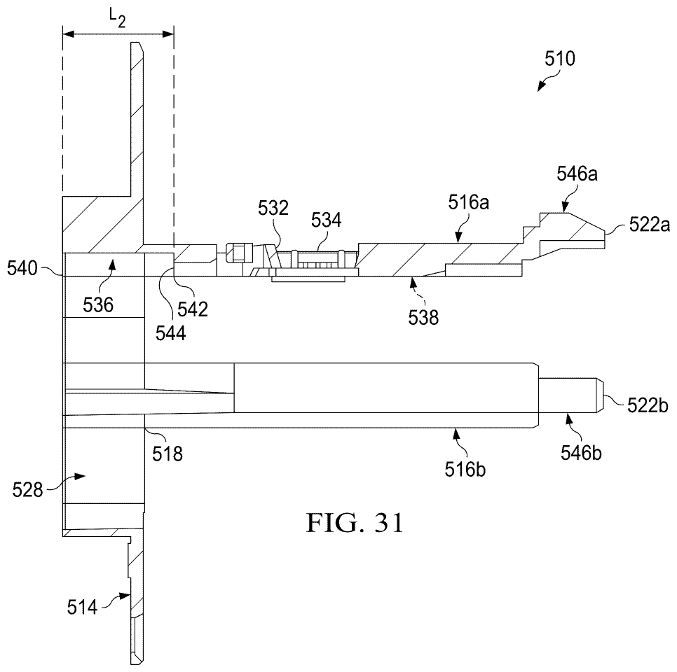

Turning to the cross-sectional view of FIG. 31, a keyway 536 configured to align with and engage the key 236 when the ribbon cartridge 500 is installed may be positioned on a cartridge mating surface 538 of the central arm 516a. The keyway 536 may be imparted with dimensions that complement or are substantially similar to the key 236. The keyway 536 may extend from a keyway proximal end 540 located on the cartridge flange interior surface 528 and terminate at a keyway terminal end 542 positioned along the central arm 516a between the cartridge flange 514 and the smart cell bay 532. Thus, the keyway 536 may be defined by a second length L₂ measured linearly between the keyway proximal end 540 and the keyway terminal end 542. The shape of the keyway 536 may mirror or be substantially similar to the shape of the keyway 436. However, in some instances, the second length L₂ may be imparted with a value less than the first length L₁. A substantially vertical keyway end wall 544 arranged to impact or otherwise engage the key 236 may be positioned at the keyway terminal end 542.

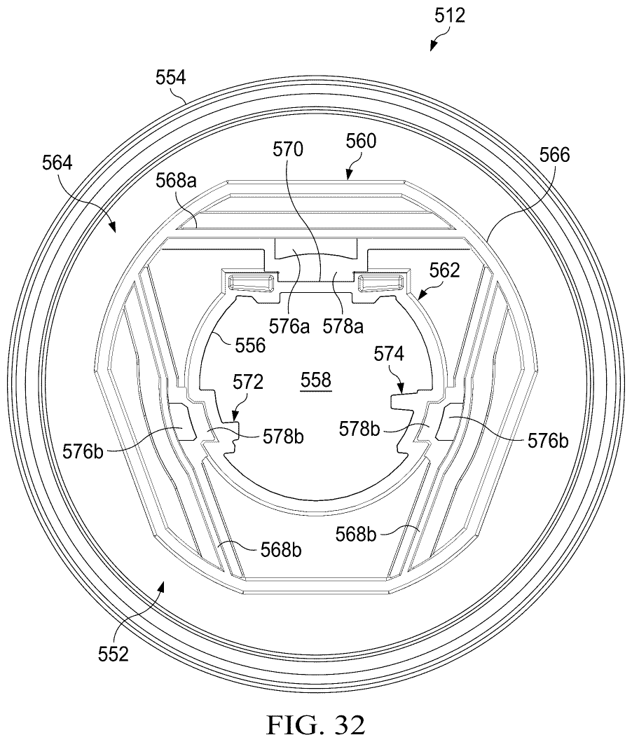

As best shown in FIG. 30, each arm 516 may include a connector 546 at the arm second end 522. The connectors 546 may be configured to be received by the end cap 512 and facilitate coupling between the support member 510 and the end cap 512. In some instances, the connectors 546 may be provided in the form of substantially rectilinear, stepped protrusions positioned at the arm second end 522a of the central arm 516a and the arm second ends 522b of the side arms 516b. In some instances, each connector 546a, 546b may be provided in substantially the same form. In other instances, the connector 546a of the central arm 516a may be imparted with a different size, shape, or structure than the connectors 546b of the side arms 516b. In still other instances, each connector 546a, 546b may be provided in any suitable form so long as the connector 546 is configured to facilitate coupling between the support member 510 and the end cap 512 as described in detail below with reference to FIG. 32.

Turning to FIGS. 32 and 33, the end cap 512 may be provided in the form of an end cap body 552 defined by an end cap exterior perimeter 554. In some instances, the end cap exterior perimeter 554 may be substantially circular. In other instances, the end cap 512 may be imparted with any suitable shape or structure (e.g., to accommodate rolls of ribbon material 134 having different sizes or widths). In some instances, the end cap 512 may include a substantially circular or irregularly shaped end cap interior surface 556 defining a central end cap opening 558 extending entirely through the end cap body 552 (e.g., to receive the spindle 200 when the ribbon cartridge 500 is installed). A substantially ring-shaped support structure 560 and a central collar 562 may be positioned on exterior face 564 of the end cap 512 and protrude outwardly therefrom. The support structure 560 may include a substantially ring-shaped outer wall 566 and one or more substantially linear panels 568. In some instances, the support structure 560 may include one central panel 568a and two side panels 568b.

The central collar 562 may include a substantially linear collar upper edge 570 proximate to the central panel 568a. Additionally, the central collar 562 may include a third poka-yoke or fail-safe member 572 and a fourth poka-yoke or fail-safe member 574, each positioned along the end cap interior surface 556 adjacent to one of the side panels 568b. In some instances, the third and fourth fail-safe members 572, 574 may be provided in the form of rectilinear or curvilinear protrusions positioned on the end cap interior surface 556. In other instances, the third and fourth fail-safe members 572, 574 may be provided in any suitable form provided that engagement between the third and fourth fail-safe members 572, 574 and the first and second fail-safe features 282, 284 of the spindle arm 226 facilitates correct installation of the ribbon cartridge 500.

The central collar 562 and the end cap opening 558 extending therethrough may be imparted with a shape and structure that complements and/or mirrors that of the spindle arm 226 as described above with reference to FIG. 14. Like the first and second fail-safe members 548, 550 of the support member 510, the third and fourth fail-safe members 572,574 of the end cap 512 may be configured to prevent or inhibit installation of the ribbon cartridge 500 on the spindle 200 with the incorrect orientation.

As best shown in FIG. 32, the end cap 512 may include one or more connection tabs 576 configured to facilitate coupling between the support member 510 and the end cap 512 by receiving or engaging the connectors 546 located at the arm second end 522 of each arm 516. In some instances, the end cap 512 may include a central connection tab 576a connected to the central panel 568a and a side connection tab 576b connected to each of the side panels 568b. For example, the central connection tab 576a may be formed integrally with or connected to the central panel 568a and extend inwardly therefrom (e.g., toward the collar upper edge 570). A connector opening 578a positioned between the central connection tab 576a and the collar upper edge 570 may be configured to permit the connector 546a of the central arm 516a to pass therethrough and to releasably engage the central connection tab 576a.

One side connection tab 576b may be formed integrally with or connected to the side panel 568b proximate to the third fail-safe member 572 and extend inwardly therefrom. A connector opening 578b positioned between the side connection tab 576b and the third fail-safe member 572 may be configured to permit the connector 546b of one of the side arms 516b to pass therethrough and to releasably engage the side connection tab 576b (see FIG. 33). The other second side connection tab 576b may be formed integrally with or connected to the side panel 568b proximate to the fourth fail-safe member 574 and extend inwardly therefrom. A connector opening 578b positioned between the side connection tab 576b and the fourth fail-safe member 574 may be configured to permit the connector 546b of the other side arm 516b to pass therethrough and to releasably engage the side connection tab 576b (see FIG. 33). Thus, the support member 510 and end cap 512 may be releasably coupled together in a manner similar to the support member 410 and end cap 412 of the ribbon cartridge 400, as described above with reference to FIG. 24.

As best shown in FIG. 33 the ribbon roll 502 may be retained between the end cap 512 and the cartridge flange 514 of the support member 510 when the ribbon cartridge 500 is assembled. The arms 516 may extend through the core 506 of the ribbon roll 402. The core opening 508 of the ribbon roll 502, the support member opening 530, and the end cap opening 558 may align and be configured to receive the spindle arm 226. Additionally, the third and fourth fail-safe members 572, 574 of the end cap 512 may align with the first and second fail-safe members 548, 550 of the support member 510, respectively. In this way, the ribbon cartridge 500 may be biased toward installation with the correct orientation (see FIG. 3A) and against installation with the incorrect orientation (see FIG. 3B).

Turning now to FIG. 34, a user may install the ribbon cartridge 500 on the spindle 200 by first positioning the ribbon cartridge 500 at the hub second end 224. The ribbon cartridge 500 may be aligned with the spindle 200 such that the spindle arm 226 is positioned to extend through the support member opening 530, the core opening 508 (not shown), and the end cap opening 558. To install the ribbon cartridge 500 with the correct orientation (see FIG. 3A), the ribbon cartridge 500 is positioned such that the cartridge flange 514 of the support member 510 is adjacent to the hub second end 224 prior to installation. Thus, as the ribbon cartridge 500 is moved onto the spindle arm 226 in the direction of the arrow 590, the spindle arm 226 may extend first through the support member opening 530, then through the core opening 508, and finally through the end cap opening 558.

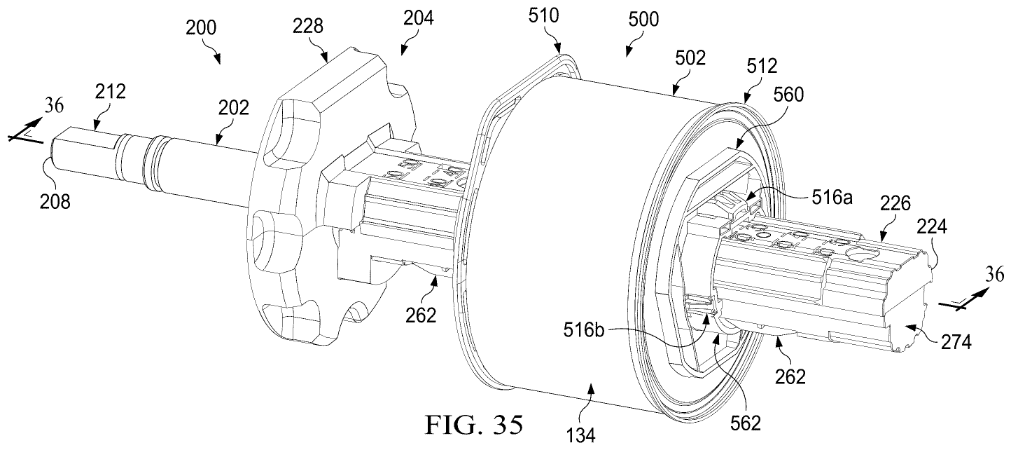

The user may continue moving the ribbon cartridge 500 along the spindle arm 226 (e.g., in the direction of the arrow 590) until the key 236 of the spindle 200 engages the keyway 536 on the cartridge mating surface 538 of the central arm 516a (see FIG. 36), creating a hard stop. For example, the key 236 may impact the keyway end wall 544 of the keyway 536 such that the ribbon cartridge 500 is no longer movable in the direction of the arrow 590. The key 236 and the keyway 536 may be designed and constructed such that engagement therebetween locates the ribbon cartridge 500 in a desired (e.g., central) position along the spindle 200 or the spindle arm 226. As shown in FIGS. 35 and 36, in some instances, the ribbon cartridge 500 may be automatically centered with respect to the spindle arm 226. In other instances, the key 236 and the keyway 536 may be configured to locate the ribbon cartridge 500 in any suitable position with respect to the spindle 200, a component of the spindle 200, or the desired printing device (e.g., the printer 100).

As the ribbon cartridge 500 moves along the spindle arm 226 to the desired position, the leaf springs 262 of the spindle 200 may engage the core 506 of the ribbon roll 502. For example, in some instances, the leaf springs 262 may reduce or eliminate the possibility of the ribbon cartridge 500 or the ribbon roll 502 tracking along the spindle arm 226 and/or moving out of alignment (e.g., by rotating relative to the spindle 200) during printing operations.

As best shown in FIG. 36, the smart cell 534 may be positioned on the central arm 516a such that, when the ribbon cartridge 500 reaches the desired position (e.g., when the key 236 engages the keyway 536), the smart cell 534 is positioned adjacent to the transmission member 218. For example, the smart cell 534 may be adjacent to the input contact tab 257 and the smart cell 534 may contact or otherwise be in communication with the input contacts 256 when the ribbon cartridge 500 reaches the desired position. The output contacts 254 (see FIG. 10) may be in communication with a processor or controller of a printing device, for example, via a wire (not shown). In this way, the output contacts 254 and input contacts 256 of the transmission member 218 may facilitate communication between a printing device (e.g., the printer 100) and the smart cell 534 such that the printing device may read or receive the information stored in the smart cell 534. For example, the printing device may verify that the ribbon cartridge 500 is intended for use with the spindle 200 and/or the printing device by receiving the authentication signal from the smart cell 534. Additionally, the printing device may receive information regarding the properties of the ribbon cartridge 500 such as the ribbon width, type, color, and the like.

In some instances, a processor, controller, or other electronic component of the printing device (e.g., the printer 100) may be configured to take corrective action in the absence of an authentication signal indicating that the ribbon cartridge 500 is intended for use with the spindle 200 and/or the printing device. For example, if the processor or controller receives a proper authentication signal, the printing device may proceed with printing operations. On the other hand, the processor or controller may be configured to take corrective action (e.g., by disallowing printing operations or generating an error message for a user) in the absence of a proper authentication signal.

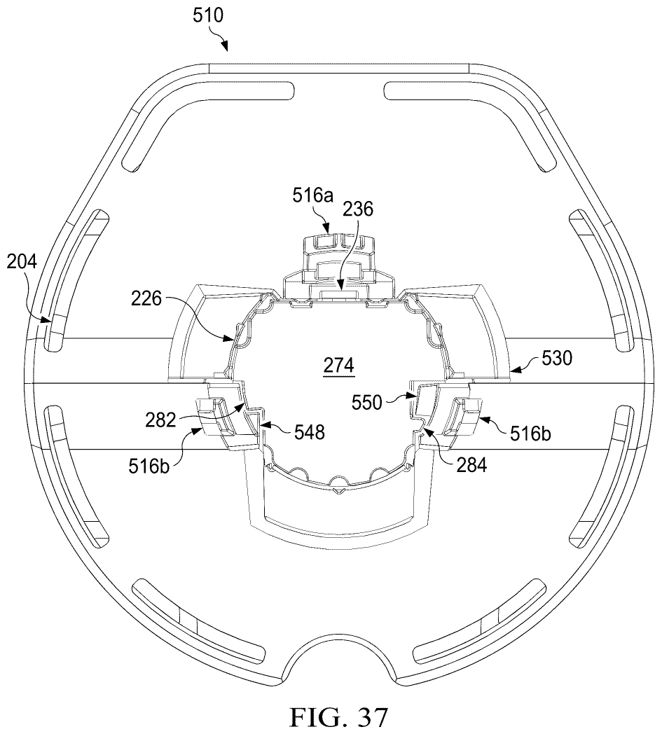

As shown in FIG. 37, when the ribbon cartridge 500 is oriented correctly, the first and second fail-safe members 548, 550 of the support member 510 do not impede installation (e.g., by impacting the first and second fail-safe features 282, 284 of the spindle arm 226). For example, the first fail-safe member 548 may be positioned adjacent to the first fail-safe feature 282 and the second fail-safe member 550 may be positioned adjacent to the second fail-safe feature 284. Thus, the support member 510 may be movable along the spindle arm 226 and the first and second fail-safe members 548, 550 may inhibit or prevent the support member 510 (and thus the ribbon cartridge 500) from moving out of alignment with the spindle 200 (e.g., by rotating relative to the spindle arm 226).

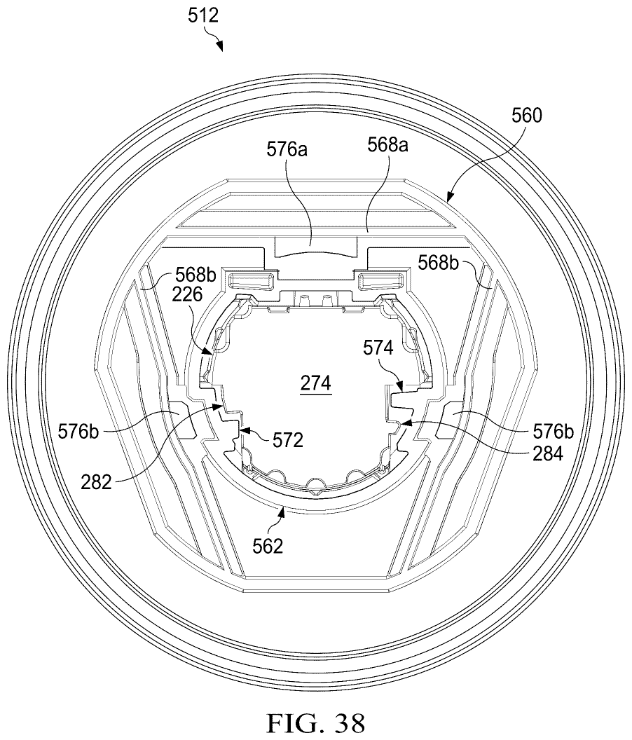

Likewise, as shown in FIG. 38, when the ribbon cartridge 500 is oriented correctly, the third and fourth fail-safe members 572, 574 of the end cap 512 do not impede installation (e.g., by impacting the first and second fail-safe features 282, 284 of the spindle arm 226). For example, the third fail-safe member 572 may be positioned adjacent to the first fail-safe feature 282 and the fourth fail-safe member 574 may be positioned adjacent to the second fail-safe feature 284. Thus, the end cap 512 may be movable along the spindle arm 226 and the third and fourth fail-safe members 572, 574 may inhibit or prevent the end cap 512 (and thus the ribbon cartridge 500) from moving out of alignment with the spindle 200 (e.g., by rotating with respect to the spindle arm 226).

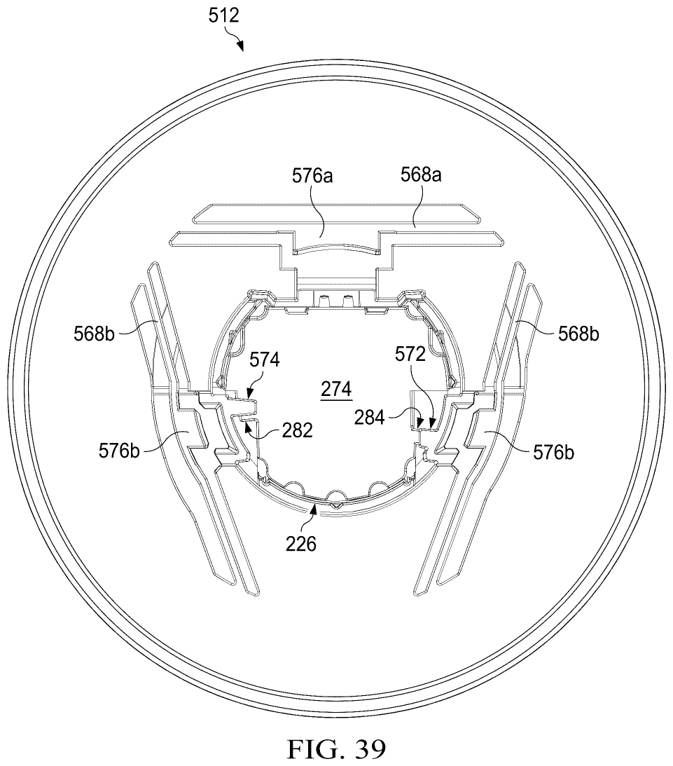

Turning to FIG. 39, the third and fourth fail-safe members 572, 574 of the end cap 512 may impede installation of the ribbon cartridge 500 when the ribbon cartridge 500 is oriented incorrectly. For example, installation may be prevented if the user orients the ribbon cartridge 500 such that the end cap 512 is positioned adjacent to the hub second end 224 prior to installation (e.g., the opposite of the orientation of the ribbon cartridge 500 depicted in FIG. 34). In that case, the third fail-safe member 572 may overlap or impact the second fail-safe feature 284 and the fourth fail-safe member 574 may overlap or impact the first fail-safe feature 282, thereby preventing or inhibiting movement of the end cap 512 (and thus the ribbon cartridge 500) along the spindle arm 226. Therefore, a user may be restricted from installing the ribbon cartridge 500 with the incorrect orientation (see FIG. 3B). In this way, the spindle 200 and ribbon cartridge 500 may prevent undesirable outcomes associated with incorrectly orienting the ribbon material 134 (e.g., blank printouts, poor print image quality, potential damage to the printhead, etc.).

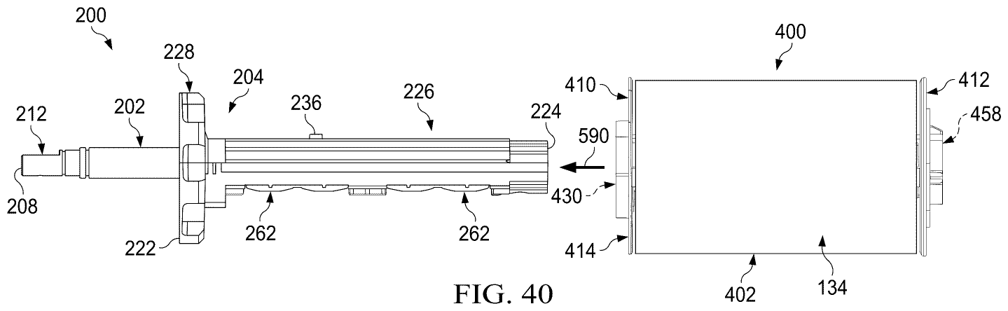

The foregoing description of the proper installation of the ribbon cartridge 500 with reference to FIGS. 34-39 may apply equally to the ribbon cartridge 400 and/or to other ribbon cartridges intended for use with the spindle 200. For example, as shown in FIG. 40, a user may install the ribbon cartridge 400 on the spindle 200 by first positioning the ribbon cartridge 400 at the hub second end 224. To ensure the correct orientation (see FIG. 3A), the ribbon cartridge 400 is oriented such that the cartridge flange 414 of the support member 410 is positioned adjacent to the spindle arm 226. Thus, when the ribbon cartridge 400 is moved onto the spindle 200 in the direction of the arrow 590, the spindle arm 226 may extend first through the support member opening 430, then through the core opening 408 (not shown) of the ribbon roll 402, and finally through the end cap opening 458.

The user may continue moving the ribbon cartridge 400 along the spindle arm 226 until the key 236 of the spindle 200 engages the keyway 436 on the cartridge mating surface 438 of the central arm 416a (see FIG. 42), creating a hard stop. For example, the key 236 may impact the keyway end wall 444 such that the ribbon cartridge 400 is no longer movable in the direction of the arrow 590. The key 236 and keyway 436 may be designed and constructed such that engagement therebetween automatically locates the ribbon cartridge 400 in a desired (e.g., central position). In some instances, the ribbon cartridge 400 may be automatically centered with respect to the spindle arm 226. In other instances, the key 236 and keyway 436 may be configured to automatically locate the ribbon cartridge 400 in any suitable position with respect to the spindle 200, a component of the spindle 200, or the desired printing device (e.g., the printer 100).

In general, the spindle 200 may be configured to automatically locate the ribbon cartridge 400, the ribbon cartridge 500, and/or other ribbon cartridges not specifically described herein independently along the spindle arm 226. For example, the difference between the length L₁ of the keyway 436 and the length L₂ of the keyway 536 (see FIGS. 36 and 42) may facilitate positioning the ribbon cartridges 400, 500 in a standard location with respect to the spindle 200 irrespective of the width of the ribbon material 134. In this way, the spindle 200 may be configured to support rolls of ribbon material 134 having different widths in the proper location and/or orientation without requiring a user to make adjustments, engage in subjective judgments, or take additional steps.

As the ribbon cartridge 400 moves along the spindle arm 226, the leaf springs 262 of the spindle 200 may engage the core 406 of the ribbon roll 402. For example, in some instances, the leaf springs 262 may reduce or eliminate the possibility of the ribbon cartridge 400 or the ribbon roll 402 tracking along the spindle arm 226 or moving out of alignment during operation of the printing device (e.g., the printer 100).

As best shown in FIG. 42, the smart cell 434 may be positioned on the central arm 416a such that, when the ribbon cartridge 400 reaches the desired position (e.g., when the key 236 engages the keyway 436), the smart cell 434 is adjacent to the transmission member 218. For example, the smart cell 434 may be adjacent to the input contact tab 257 and the smart cell 434 may contact or otherwise be in communication with the input contacts 256 when the ribbon cartridge 400 reaches the desired position. The output contacts 254 (see FIG. 10) may be in communication with a processor or controller of a printing device, for example, via a wire (not shown). In this way, the output contacts 254 and input contacts 256 of the transmission member 218 may facilitate communication between a printing device (e.g., the printer 100) and the smart cell 434 such that the printing device may read or receive the information stored in the smart cell 434. For example, the printing device may verify that the ribbon cartridge 400 is intended for use with the spindle 200 and/or the printing device by receiving the authentication signal from the smart cell 434. Additionally, the printing device may receive information regarding the properties of the ribbon cartridge 400 such as the ribbon width, type, color, and the like.

In some instances, a processor, controller, or other electronic component of the printing device (e.g., the printer 100) may be configured to take corrective action in the absence of an authentication signal indicating that the ribbon cartridge 500 is intended for use with the spindle 200 and/or the printing device. For example, if the processor or controller receives a proper authentication signal, the printing device may proceed with printing operations. The processor or controller may be configured to take corrective action (e.g., by disabling printing operations or generating an error message for a user) in the absence of a proper authentication signal.

The first and second fail-safe members 448, 450 and the third and fourth fail-safe members 472, 474 may prevent incorrect installation of the ribbon cartridge 400 in the same manner as the first and second fail-safe members 548, 550 and the third and fourth fail-safe members 572, 574, as described above with reference to FIGS. 37-39. Therefore, a user may be restricted from installing the ribbon cartridge 400 with the incorrect orientation (see FIG. 3B), which can lead to blank printouts, poor print image quality, potential damage to the printhead, and/or other undesirable outcomes.

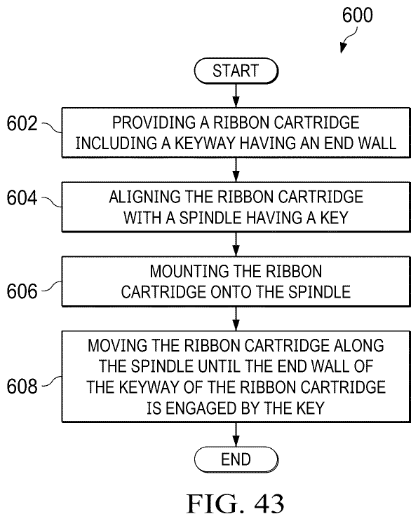

FIG. 43 illustrates a method 600 of installing a ribbon cartridge on a spindle (e.g., spindle 200) in a printer (e.g., printer 100).

At a step 602, a ribbon cartridge (e.g., ribbon cartridge 400, 500) is provided. The ribbon cartridge may have a first width (e.g., W₁) and be provided at a first time. Or the ribbon cartridge may have a second width (e.g., W₂) that is different than the first width and be provided at a second time that is different than the first time (e.g., before or after the first time). The ribbon cartridge may include a support member (e.g., support member 410, 510) extending between a first end (e.g., arm first end 418, 518) of the ribbon cartridge and a second end (e.g., arm second end 422, 522) of the ribbon cartridge opposing the first end. The support member may include a first opening (e.g., support member opening 430, 530) and a keyway (e.g., keyway 436, 536) having an end wall (e.g., keyway end wall 444, 544). The ribbon cartridge may include an end cap (e.g., end cap 412, 512) positioned at the second end of the ribbon cartridge. The end cap may include a second opening (e.g., end cap opening 458, 558).

At a step 604, the ribbon cartridge is aligned with the spindle such that the first end of the ribbon cartridge is positioned adjacent to the spindle.

At a step 606, the ribbon cartridge is mounted onto the spindle such that the spindle extends through the first opening before extending through the second opening.

At a step 608, the ribbon cartridge is moved along the spindle until the end wall of the keyway is engaged by a key (e.g., key 236) positioned on the spindle, and the method ends.

It will be appreciated by those skilled in the art that while the above disclosure has been described above in connection with particular embodiments and examples, the above disclosure is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference as if each such patent or publication were individually incorporated by reference herein. Various features and advantages of the above disclosure are set forth in the following claims.

1. A system for installing ribbon material in a printer, comprising:
a spindle provided in the form of a spindle arm and a key associated with the spindle arm; and
a ribbon cartridge having a keyway arranged to align with the key of the spindle arm and a ribbon roll including a supply of ribbon material,
wherein engagement between the key and the keyway positions the ribbon cartridge on the spindle arm in a correct orientation.

2. The system of claim 1, wherein engagement between the key and the keyway centers the ribbon cartridge with respect to the spindle arm.

3. The system of claim 2, wherein the ribbon material is imparted with one of a first width or a second width, wherein the first width is less than the second width.

4. The system of claim 1, wherein engagement between the key and the keyway centers the ribbon cartridge with respect to the printer.

5. The system of claim 1, wherein the supply of ribbon material is wound about a core of the ribbon roll, the spindle further comprising one or more leaf springs for inhibiting the ribbon roll from moving out of alignment with respect to the spindle arm during operation of the printer.

6. The system of claim 1, the ribbon cartridge having a first end and a second end opposing the first end, wherein the keyway is positioned at the first end and the first end must be installed on the spindle before the second end in order for the keyway to engage the key and position the ribbon cartridge in the correct orientation.

7. The system of claim 1, the ribbon cartridge further comprising a support member and an end cap releasably couplable to the support member.

8. The system of claim 1, the spindle further comprising a transmission member, and the ribbon cartridge further comprising a smart cell capable of transmitting an electrical signal to the printer via the transmission member, wherein the printer detects whether the ribbon cartridge is intended for use with the spindle based on the electrical signal transmitted by the smart cell.

9. The system of claim 1, the spindle further comprising one or more fail-safe features and the ribbon cartridge further comprising one or more fail-safe members, wherein the fail-safe members are configured to engage the fail-safe features and inhibit installation of the ribbon cartridge with an incorrect orientation relative to the spindle.

10. A ribbon cartridge for installation on a spindle of a printer, comprising:
a supply of ribbon material; and
a ribbon holder for holding the supply of ribbon material, the ribbon holder including:
a support member having a flange, a first opening extending through the flange, and a first fail-safe member disposed about the first opening; and
an end cap releasably couplable to the support member, the end cap including a second opening extending therethrough and a second fail-safe member disposed about the second opening,
wherein the first fail-safe member and the second fail-safe member are configured to engage at least a portion of the spindle when the ribbon cartridge is being installed in an incorrect orientation, and
wherein engagement between the spindle and the first fail-safe member or the second fail-safe member inhibits movement of the ribbon cartridge along the spindle.

11. The ribbon cartridge of claim 10, wherein the spindle comprises a spindle arm having a first fail-safe feature positioned on the spindle arm.

12. The ribbon cartridge of claim 11, wherein the first fail-safe member of the support member protrudes inwardly with respect to the first opening,
wherein the second fail-safe member of the end cap protrudes inwardly with respect to the second opening, and
wherein the first fail-safe member is positioned to align with the second fail-safe member when the ribbon cartridge is assembled.

13. The ribbon cartridge of claim 12, wherein the first fail-safe member is arranged to impact the first fail-safe feature when the ribbon cartridge is being installed on the spindle with the incorrect orientation, and
wherein an impact between the first fail-safe member and the first fail-safe feature inhibits installation of the ribbon cartridge on the spindle.

14. The ribbon cartridge of claim 12, wherein the second fail-safe member is arranged to impact the first fail-safe feature when the ribbon cartridge is installed on the spindle with the incorrect orientation, and
wherein an impact between the second fail-safe member and the first fail-safe feature inhibits installation of the ribbon cartridge on the spindle.

15. The ribbon cartridge of claim 10, wherein the first fail-safe member of the support member and the second fail-safe member of the end cap permit installation of the ribbon cartridge in a first orientation and inhibit installation of the ribbon cartridge in a second orientation.

16. The ribbon cartridge of claim 15, wherein the first orientation allows the ribbon material to be fed through the printer with a correct ink face orientation.

17. The ribbon cartridge of claim 10, wherein a leaf spring positioned on the spindle engages the ribbon cartridge and inhibits the ability of the ribbon cartridge to move out of alignment with respect to the spindle during operation of the printer.

18. A method of installing a ribbon cartridge on a spindle of a printer, comprising the steps of:
providing a ribbon cartridge comprising:
a support element positioned at a first end of the ribbon cartridge, the support element including a first opening and a keyway having an end wall; and
an end cap positioned at a second end of the ribbon cartridge opposing the first end, the end cap having a second opening;
aligning the ribbon cartridge with the spindle such that the first end of the ribbon cartridge is positioned adjacent to the spindle;
mounting the ribbon cartridge onto the spindle such that the spindle extends through the first opening before extending through the second opening; and
moving the ribbon cartridge along the spindle until the end wall of the keyway is engaged by a key positioned on the spindle.

19. The method of claim 18, wherein providing a ribbon cartridge, further comprises the steps of:
providing a ribbon cartridge having a first width at a first time; and
providing a ribbon cartridge having a second width at a second time,
wherein the first width is different than the second width, and
wherein the first time is different from the second time.

20. The method of claim 18, wherein engagement between the end wall of the keyway and the key centers the ribbon cartridge with respect to the spindle.
